(19) United States
(12) Patent Application Publication
(10) Pub. No.: US 2026/0147988 A1
(43) Pub. Date: May 28, 2026

(54) INFORMATION PROCESSING APPARATUS, INFORMATION PROCESSING SYSTEM, AND INFORMATION PROCESSING METHOD

(71) Applicant: Tatsuma HIROKAWA, Kanagawa (JP)

(72) Inventor: Tatsuma HIROKAWA, Kanagawa (JP)

(21) Appl. No.: 19/394,935

(22) Filed: Nov. 20, 2025

(30) Foreign Application Priority Data
Nov. 27, 2024 (JP) 2024-206340

(51) Int. Cl. G06F 40/174

(52) U.S. Cl. CPC G06F 40/174

(57) ABSTRACT

An information processing apparatus includes circuitry that registers information input on a screen displayed on a terminal apparatus, the screen being configured to receive an instruction for extracting information to be input to an input field of an input item from image data, transmits, to a generative AI system, a request including the image data from which the information is extracted and the instruction for extracting the information corresponding to the input item from the image data, receives the information corresponding to the input item from the generative AI system, and transmits, to the terminal apparatus, the information corresponding to the input item and received from the generative AI system, to cause the terminal apparatus to display the screen in which the information corresponding to the input item is input to the input field of the corresponding input item.

### CROSS-REFERENCE TO RELATED APPLICATION

This patent application is based on and claims priority pursuant to 35 U.S.C. § 119(a) to Japanese Patent Application No. 2024-206340, filed on Nov. 27, 2024, in the Japan Patent Office, the entire disclosure of which is hereby incorporated by reference herein.

### BACKGROUND

### Technical Field

The present disclosure relates to an information processing apparatus, an information processing system, and an information processing method.

### Related Art

A technique in the related art uses artificial intelligence (AI) to analyze image data and output an analysis result. An information processing apparatus equipped with AI can output things captured in image data, classify image data, and detect an abnormality in image data, for example.

### SUMMARY

The present disclosure described herein provides an information processing apparatus communicably connected to a terminal apparatus and a generative artificial intelligence (AI) system via a network. The information processing apparatus includes circuitry, which registers information input on a screen displayed on the terminal apparatus. The screen is a screen configured to receive an instruction for extracting information to be input to an input field of an input item from image data. In response to reception of the instruction on the screen, the circuitry transmits to the generative AI system a request including the image data from which the information is extracted and the instruction for extracting the information corresponding to the input item from the image data. The circuitry receives the information corresponding to the input item from the generative AI system in response to the request. The circuitry transmits, to the terminal apparatus, the information corresponding to the input item and received from the generative AI system, to cause the terminal apparatus to display the screen in which the information corresponding to the input item is input to the input field of the corresponding input item.

The present disclosure described herein provides an information processing system including an information processing apparatus and a terminal apparatus communicably connected to the information processing apparatus via a network. The terminal apparatus includes first circuitry. The first circuitry displays a screen for receiving input of a value to an input field of an input item. The screen is configured to receive an instruction for extracting a value to be input to the input field from image data. In response to reception of the instruction on the screen, the first circuitry transmits, to the information processing apparatus, a request including the image data from which the value is extracted and the instruction for extracting the value corresponding to the input item from the image data. The information processing apparatus includes second circuitry. The second circuitry transmits the request received from the terminal apparatus to a generative artificial intelligence (AI) system, receives the value corresponding to the input item from the generative AI system in response to the request, and transmits, to the terminal apparatus, the value corresponding to the input item and received from the generative AI system. The first circuitry displays the screen in which the value corresponding to the input item and received from the information processing apparatus is input to the input field of the corresponding input item, and transmits the value input to the input field to the information processing apparatus. The second circuitry registers the value input to the input field and received from the terminal apparatus.

The present disclosure described herein provides an information processing method performed by an information processing apparatus communicably connected to a terminal apparatus and a generative artificial intelligence (AI) system via a network. The information processing method includes registering information input on a screen displayed on the terminal apparatus, the screen being configured to receive an instruction for extracting information to be input to an input field of an input item from image data; in response to reception of the instruction on the screen, transmitting to the generative AI system a request including the image data from which the information is extracted and the instruction for extracting the information corresponding to the input item from the image data; receiving the information corresponding to the input item from the generative AI system in response to the request; and transmitting, to the terminal apparatus, the information corresponding to the input item and received from the generative AI system, to cause the terminal apparatus to display the screen in which the information corresponding to the input item is input to the input field of the corresponding input item.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an application creation screen displayed by a user terminal;

FIG. 2 is a diagram illustrating an example of an input screen of a business card management application displayed by the user terminal;

FIG. 3 is a diagram illustrating an example of a process in which a user inputs values for input items of the business card management application;

FIG. 4 is a diagram for describing an example of a process of an information setting service performed by an information processing system;

FIG. 5 is a diagram illustrating an example of a system configuration of the information processing system;

FIG. 6 is a diagram illustrating an example of a hardware configuration of an application service, the user terminal, and a developer terminal;

FIG. 7 is a diagram illustrating an example of a functional configuration of the application service and the user terminal;

FIG. 8 is a diagram illustrating an example of information set for input items of an application;

FIG. 9 is a diagram illustrating an example of information related to the input items of the application;

FIG. 10 is a sequence diagram for describing an example of a process performed by the information processing system;

FIG. 11 is a diagram illustrating an example of parameters included in a request message transmitted by the application service to a generative AI system in step S4 in FIG. 10;

FIG. 12 is a diagram illustrating an example of a prompt set in “prompt” in FIG. 11;

FIG. 13 is a diagram illustrating an example of a format of a response message transmitted by the generative AI system to the application service in step S5 in FIG. 10;

FIG. 14 is a diagram illustrating an example of the input screen of the business card management application displayed by the user terminal;

FIG. 15 is a diagram illustrating an example of the prompt generated by a request generation unit;

FIG. 16 is a diagram illustrating an example of a response message from the generative AI system in response to a request message including the prompt illustrated in FIG. 15;

FIG. 17 is a diagram illustrating an example of the input screen of the business card management application in which values are set in the business card management application;

FIG. 18 is a diagram illustrating an example of an input screen of a book management application displayed by the user terminal;

FIG. 19 is a diagram illustrating an example of information related to input items of the book management application;

FIG. 20 is a diagram illustrating an example of a prompt generated by the request generation unit;

FIG. 21 is a diagram illustrating an example of a response message from the generative AI system in response to a request message including the prompt illustrated in FIG. 20;

FIG. 22 is a diagram illustrating an example of the input screen of the book management application in which values are set in the book management application;

FIG. 23 is a diagram for describing an example of a method of setting values for the input items using a function call capability;

FIG. 24 is a diagram illustrating an example of a request message including arguments of a function;

FIG. 25 is a diagram illustrating an example of a response message from the generative AI system when the generative AI system has the function call capability;

FIG. 26 is a diagram illustrating an example of an image data selection screen displayed as a portion or a pop-up screen of the input screen of the business card management application;

FIG. 27 is a diagram illustrating an example of information related to an input item having an input range;

FIG. 28 is a diagram illustrating an example of a prompt for requesting values for the input items in a JavaScript® Object Notation (JSON) format;

FIG. 29 is a diagram illustrating an example of a request message when the generative AI system has the function call capability;

FIG. 30 is a diagram illustrating an example of a prompt using few-shot prompting;

FIG. 31 is a sequence diagram for describing an example of a process performed by the information processing system when few-shot prompting is used;

FIG. 32 is a diagram illustrating an example of a request message transmitted by the application service to the generative AI system; and

FIG. 33 is a diagram illustrating an example of character strings set in “prompt” in FIG. 32.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and a setting method performed by the information processing system will be described below as an example of embodiments of the present disclosure.

### Application Service

An application service is a service for assisting a user in creating applications in a low-code or no-code manner. Such a service is also called visual programming. The application service transmits a web application for assisting a user in creating applications to a user terminal operated by the user. This allows the user to operate the web application executed on the user terminal to create various applications.

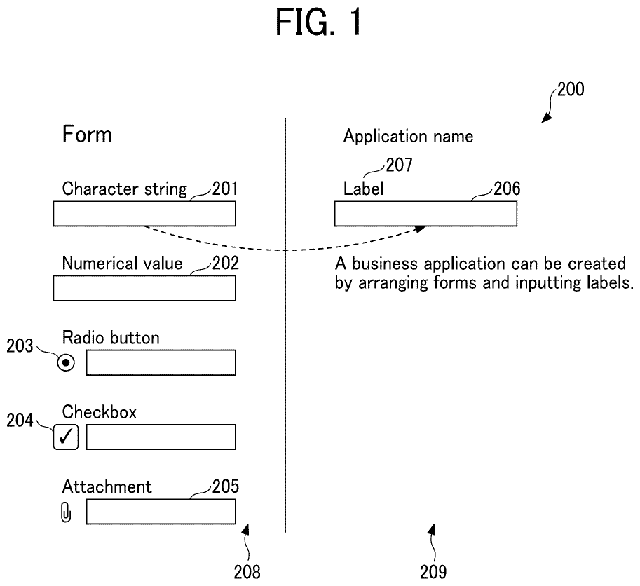

FIG. 1 illustrates an application creation screen 200 displayed by the user terminal. For example, the application creation screen 200 includes a form area 208 and a work area 209. The form area 208 displays a list of forms to be arranged in an application. The forms are display components of a screen. Examples of the forms include a text input form, a selection form, and a file registration form. FIG. 1 illustrates a character string form 201, a numerical value form 202, a radio button form 203, a checkbox form 204, and an attachment form 205. The aforementioned forms are merely an example.

The character string form 201 is a form for inputting a character string. Full-width characters, half-width characters, numerical values, symbols, and the like can be input to the character string form 201.

The numerical value form 202 is a form for inputting a numerical value. Only numerical values can be input to the numerical value form 202.

The radio button form 203 is a form for a button that receives selection of one option from among a plurality of options. The radio button form 203 has a field to display an option.

The checkbox form 204 is a form for a checkbox that receives selection of one or more options from among a plurality of options. The checkbox form 204 has a field to display an option.

The attachment form 205 is a form for receiving a setting of a file to be registered to the application. The attachment form 205 may have a restriction on the format of a file to be received for registration.

The work area 209 is an area in which the user arranges forms. The user operates a mouse pointer to drag and drop a form in the form area 208 to the work area 209. Alternatively, the user operates a touch panel with their finger or stylus to drag and drop a form to the work area 209.

A form arranged in the work area 209 is referred to as an input item 206. The input item 206 has one or more input fields. For simplicity, the input field may be simply referred to as an “input item” below.

For the input item 206, a label 207 can be displayed. The label 207 is a name of the input item 206. The user inputs an appropriate label for the input item 206. The user repeats this operation to create any application. For example, the user arranges the character string forms 201 in the work area 209, and inputs labels such as “name” and “company”. In this manner, the user can create a business card management application described below. The position of the input item 206 already arranged in the work area 209 is changeable.

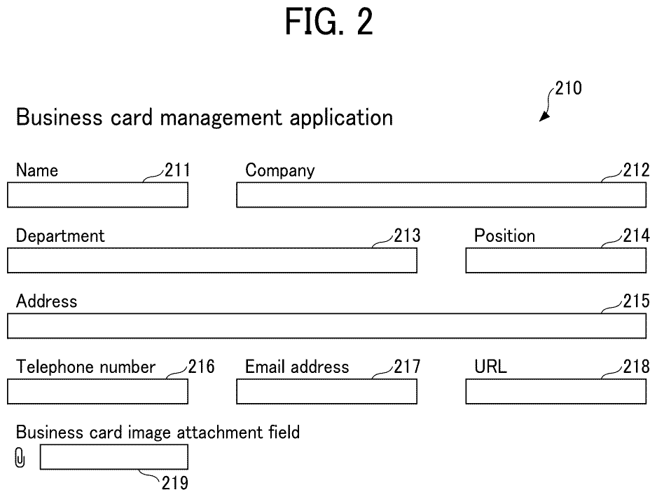

FIG. 2 illustrates an example of an input screen 210 of the business card management application displayed by the user terminal. The business card management application has a name field 211, a company field 212, a department field 213, a position field 214, an address field 215, a telephone number field 216, an email address field 217, a Uniform Resource Locator (URL) field 218, and a business card image attachment field 219. These fields are input items. The application thus created is available to users for their work or personal purposes. For example, in the business card management application, a user inputs information written on a business card received from a client, to each input item. In this manner, the business card management application enables digitization of the information. Alternatively, the business card management application enables sharing of the business card information among a team.

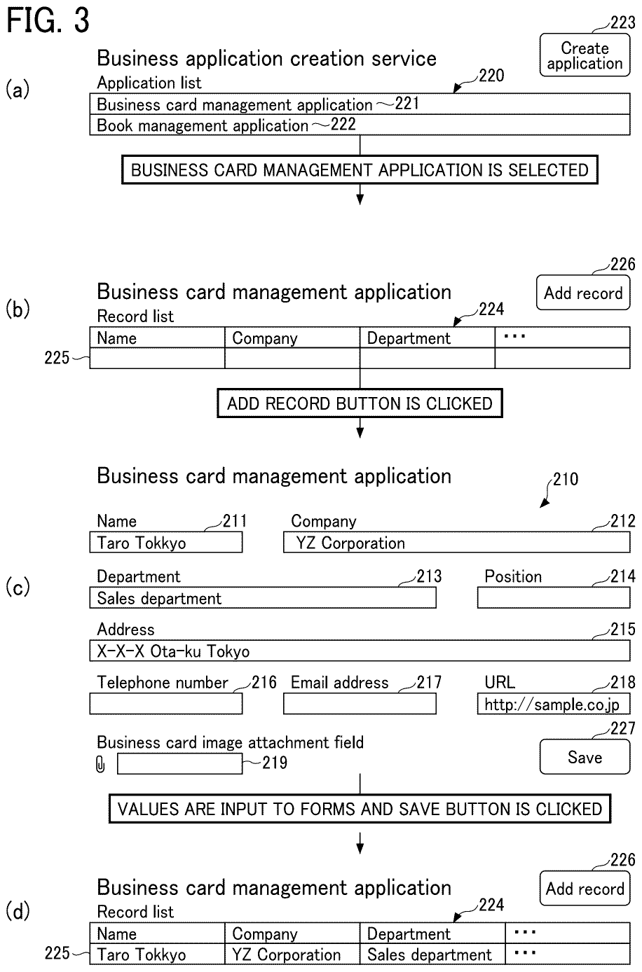

FIG. 3 is a diagram for describing an example of a procedure in which a user inputs values for input items of the business card management application. FIG. 3(a) illustrates an application list 220 displayed by the user terminal operated by the user. The application list 220 is a list of applications created and registered to the application service by users in the procedure illustrated in FIG. 1. For example, the application list 220 displays a business card management application 221 and a book management application 222. In this example, the user selects the business card management application 221. Note that a create application button 223 is a button for displaying the screen illustrated in FIG. 1.

FIG. 3(b) illustrates a record list 224 displayed by the user terminal. The record list 224 displays, as a table, a list of pieces of business card information registered to the business card management application 221. A record refers to data of one row when pieces of data in a database are arranged in a two-dimensional table. One record corresponds to one piece of business card information. A record 225 has a plurality of input items. These input items may be called fields. One vertical line of the table is referred to as a column. In FIG. 3(b), since no business card information is registered, the record list 224 is empty.

In response to the user pressing an add record button 226, the input screen 210 of the business card management application 221 is displayed. FIG. 3(c) illustrates the input screen 210 of the business card management application 221. As described above, the input screen 210 of the business card management application 221 includes the input items created by the user for the business card management application 221. The user inputs values for the respective input items, and presses a save button 227. The input content (in this case, the business card information) is saved as a record in the application service.

FIG. 3(d) illustrates the record list 224 displayed by the user terminal. The business card information input on the input screen 210 of the business card management application 221 in FIG. 3(c) is displayed as one record.

As described above, since a keyboard is usually used for input to the input items, the workload of the user is large. In addition, a mistake may occur during the input.

### Process Flow

Accordingly, in the present embodiment, the user terminal transmits, to the application service, a file (i.e., image data of a business card) input to the attachment form 205 and a list of input items of an application. The application service requests a generative AI system to generate values to be set for the input items. The generative AI system performs various natural language processing tasks, such as text generation, question answering, text classification, sentiment analysis, information extraction, and sentence summarization. An example of the generative AI system is Copilot®, which proposes codes to be written next while the user is coding a program. In the present embodiment, a technique will be described in which the generative AI system extracts information from the image data without having a conversation (also referred to as a chat) with the user. The generative AI system or the functions thereof may be simply referred to as artificial intelligence (AI).

The generative AI system analyzes the image data and the list of input items, generates values to be input for the input items, and transmits the generated values to the application service. The application service receives the generated values, and transmits the generated values to the user terminal. The generative AI system may be provided as a system different from a system that provides a service related to the application. The service related to the application and the generative AI system may be provided by the same provider. The user terminal receives the generated values, and sets the generated values to the application service. The user is allowed to create any applications used for their work or the like as well as the business card management application, by using the application service. Thus, the information processing system according to the present embodiment generates a value appropriate for an input item of any application from image data, and sets the generated value for the input item in the application service.

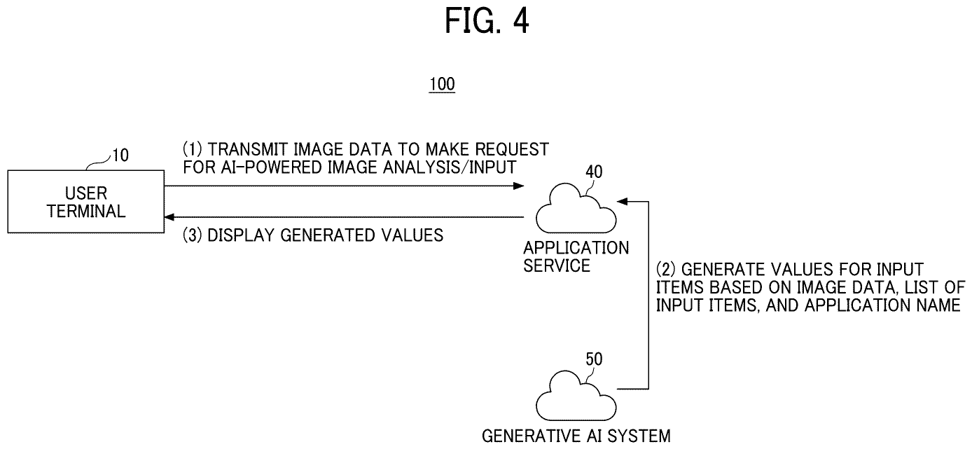

FIG. 4 is a diagram for describing a process in which an information processing system 100 sets values in an application service 40. A user terminal 10 executes a web application. An application having input items to which values are to be set has already been created in the application service 40. A generative AI system 50 analyzes image data of a business card or the like and a list of input items of the application, and generates values to be set for the input items.

(1) The user terminal 10 displays an input screen of the application. The user sets, for example, image data of a business card in the input screen, and desires to automatically set values generated by the generative AI system 50 for the rest of the input items. The user presses a predetermined button to transmit a request for AI-powered image analysis/input to the application service 40 together with the image data.

(2) The application service 40 identifies a list of input items and an application name of the application executed by the user terminal 10. In some embodiments, the application name may be omitted. In some embodiments, the application service 40 may acquire an explanation note of the application, which is an explanation of the application and set in advance by the user), instead of the application name. The application service 40 transmits application-related information (i.e., the list of input items, the image data, and the application name) to the generative AI system 50, and receives values to be input for the input items. Specifically, the generative AI system 50 analyzes the image data, the list of input items, and the application name. The generative AI system 50 performs character recognition on the image data and generates a feature quantity indicating, for example, features of the image data to generate the values corresponding to the input items.

(3) The application service 40 transmits the values acquired from the generative AI system 50 in association with the respective input items, to the user terminal 10. Thus, the user terminal 10 displays the input screen in which the values are set for the respective input items to allow the user to check the generated values. In response to the user pressing a register button or the like, the user terminal 10 transmits the values associated with the respective input items to the application service 40. The application service 40 sets the values in a record of the application.

As described above, the information processing system 100 can set values for input items of any application.

### Terminology

An application is an abbreviation of an application program. In this disclosure, an application is a program generated by a computer according to a certain task. An operating system (OS) is general-purpose software that provides basic functions and systems for operations performed by the computer such as the file system, communication, and display control. The application provides specific functions while operating on the OS. Examples of the application include a web application and a native application. In the present disclosure, any of the web application and the native application may be developed.

An Application Programming Interface (API) is an interface for the application (software), which functions as a contact point for connecting the systems to each other to share functions and mechanisms. The API defines the specification of an interface used by the applications to exchange information with each other. The API between the computers defines, for example, the specification for one web site to communicate with another web site by Hypertext Transfer Protocol (HTTP) or Hypertext Transfer Protocol Secure (HTTPS) communication. Through communicating, the one web site may use the functions provided by the other web site. The API between the computers may be referred to as a web-API.

When the API transmits a specific request (for example, data acquisition, update, deletion, or processing), the API returns a result (for example, data, an update result, a deletion result, or a processing result) in response to the request. The request may be referred to as a request message, and the result may be referred to as a response message. Calling an API means transmitting a request and acquiring a result in accordance with the specification of the API. Calling an API may also be referred to as executing, operating, tapping, or using.

The user is an end user who uses the application provided by the application service 40. The user can also develop the application. A developer is a person who makes desired settings in the application service 40 in order to allow the development of an application by no-code or low-code programming and the use of the application.

An input item is each item having an input field for inputting information. In the input field, various kinds of information can be input. For example, image data, audio data, video data, a file, and information for selecting an option as well as a character string, a numerical value, and a symbol may be input.

Information corresponding to the input item is information to be set for the input field of the input item. The information corresponding to the input item is included in the image data, for example. A generative AI system determines whether information is the information corresponding to the input item based on the label of the input item, a data format, and the like to extract the information corresponding to the input item from the image data.

### First Embodiment

### Example of System Configuration

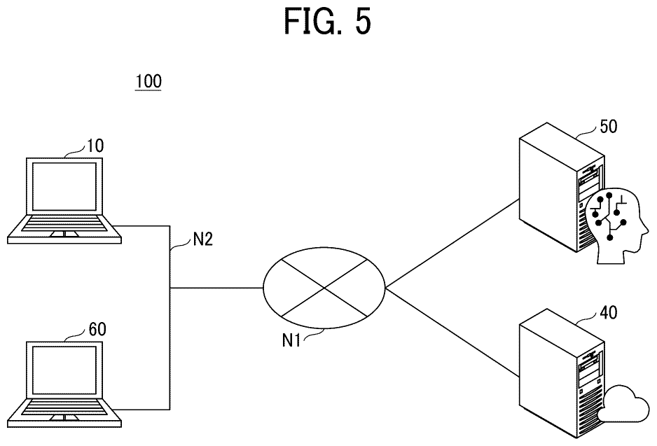

A system configuration of the information processing system 100 will be described with reference to FIG. 5. FIG. 5 is a diagram illustrating an example of the system configuration of the information processing system 100. The information processing system 100 illustrated in FIG. 5 includes the user terminal 10, a developer terminal 60, and the application service 40. The user terminal 10 and the developer terminal 60 are communicably connected to the application service 40 via networks N1 and N2. The information processing system 100 may further include the generative AI system 50. The user terminal 10 and the developer terminal 60 are communicably connected to the generative AI system 50 via the networks N1 and N2. The application service 40 may communicate with the generative AI system 50 via APIs.

The user terminal 10 and the developer terminal 60, which are disposed at facilities such as companies or homes, are connected to the network N2. The network N2 may be a local area network (LAN), Wi-Fi®, wide-area Ethernet®, or a mobile phone network such as 4G, 5G, or 6G. The network N1 is a network for a wide area, such as Internet or a wide area network (WAN). The user terminal 10 and the developer terminal 60 are not necessarily connected to the network N2 all the time in some cases. The user terminal 10 and the developer terminal 60 may be connected when the generative AI system 50 or the application service 40 is used.

The generative AI system 50 provides a service for the user to make a conversation with the AI in a natural language. An example of the generative AI system 50 is a system that uses a large language model (LLM). An LLM is a natural language processing model trained on a large amount of text data. The generative AI system 50 takes in a vast amount of text, and obtains knowledge from the input text, for example, by deep learning or reinforcement learning. The generative AI system 50 uses this knowledge to provide a response message to a chat message. The chat message includes a prompt (described later) and image data. The prompt refers to text data in the chat message.

The generative AI system 50 that generates sentences in response to data based on a chat message may be referred to as a “generative AI”. In the present embodiment, the response message returned by the generative AI system 50 is used to generate a value of an input item of an application that operates on the application service 40. The application that operates on the application service 40 includes a web application that operates on the application service 40 and a native application that is installed on the user terminal 10. When the native application installed on the user terminal 10 is executed by the user terminal 10, the native application is connected to the application service 40 and executes the functions of the application service 40.

The generative AI system 50 has the following features.

First, the generative AI system 50 can keep the natural flow of conversation.

Second, the generative AI system 50 can make a proposal by expanding ideas even in the field that the user has no knowledge.

Third, the generative AI system 50 can output accurate program codes.

Taking advantage of such features, the application service 40 provides the generative AI system 50 with the list of input items of the application and the image data, and thus can obtain values to be set for the input items from the generative AI system 50.

One of the three features is a function call capability (also referred to as “tool_call” or “function_call”). The present embodiment can be implemented in both a mode of using the function call capability and a mode of not using the function call capability. Since “tool_call” returned by the generative AI system 50 is accurate (highly reproducible), increasing the possibility of obtaining the values for the input items in a JSON format.

Examples of the generative AI system 50 include systems that use an LLM such as GPT-3®, GPT-4®, Transformer®, and BERT®. The information processing system 100 may use, for example, ChatGPT using GPT-3 or GPT-4. Alternatively, the information processing system 100 may use a system using another LLM.

The application service 40 is one or more information processing apparatuses that provide an application to be executed by the user. The application service 40 is a server apparatus that provides an application for managing information input by the user to input fields of input items. The application provided by the application service 40 is, for example, a database-based web application that manages data in a table format. The user is allowed to create any input items of the application and customize the application to save, read, or process data related to their work. The application service 40 has a plurality of applications, and the business card management application or the book management application is one of the plurality of applications.

In the present embodiment, the user sets image data of a business card or the like in the application. The user terminal 10 provides the application service 40 with the image data to request the application service 40 to provide AI-powered input. The application service 40 transmits the application-related information to the generative AI system 50, and thus receives a response message (i.e., input items and values thereof) from the generative AI system 50. The application service 40 transmits the input items and the values thereof to the user terminal 10. Thus, the user can automatically set information, which is supposed to be manually input, to the application from the image data.

Examples of the application service 40 include a cloud service, an application service provider (ASP), and a Software as a Service (SaaS), and may include various services to be provided via a network. Examples of the service to be provided include a database providing service and a storage service. The application service 40 may be on the Internet or on premises.

The functions of the application service 40 may be distributed to a plurality of information processing apparatuses. A plurality of application services 40 having the same functions may be present, and the number of information processing apparatuses having the functions of the application services 40 may be changed in accordance with the processing load.

A web server may be present separately from the application service 40, and the web server may communicate with the user terminal 10. In this case, the web server communicates with the application service 40 on behalf of the user terminal 10.

A server is a computer or software having a function of providing information or a processing result in response to a request from a client.

The application service 40 receives various settings from the developer terminal 60. The various settings include registration of a user to the application service 40 and registration of a web application for creating a chat message. That is, an administrator (e.g., developer) performs a work in the application service 40 to enable the setting of values for input items of an application using the generative AI system 50.

The user terminal 10 or the developer terminal 60 is, for example, a terminal apparatus such as a personal computer (PC), a smartphone, or a tablet terminal, which is operated by the user or the developer. The web browser or the native application operates on the user terminal 10 or the developer terminal 60.

The developer operates the developer terminal 60 to create the setting information related to the application.

The administrator (e.g., developer) or the user operates the developer terminal 60 or the user terminal 10 to use various services provided by the generative AI system 50 or the application service 40.

The user terminal 10 or the developer terminal 60 may be implemented by an information processing apparatus. Examples of the information processing apparatus include an output apparatus such as an electronic whiteboard or a digital signage, a head-up display (HUD), an industrial machine, an imaging apparatus such as a digital camera, a sound collecting apparatus, a medical device, a network home appliance, a mobile phone, a smartphone, a tablet terminal, a car navigation system, a game machine, a personal digital assistant (PDA), and a wearable PC.

### Example of Hardware Configuration

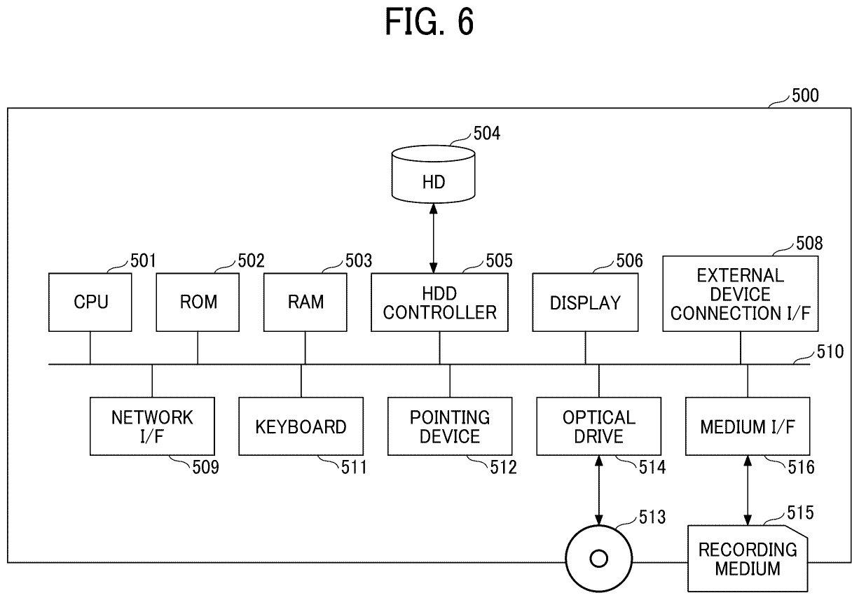

A hardware configuration of the application service 40, the user terminal 10, and the developer terminal 60 included in the information processing system 100 will be described with reference to FIG. 6. The generative AI system 50 has substantially the same hardware configuration as that illustrated in FIG. 6 or a hardware configuration of an information processing apparatus that supports cloud computing.

### Application Service 40, User Terminal 10, and Developer Terminal 60

FIG. 6 is a diagram illustrating an example of the hardware configuration of the application service 40, the user terminal 10, and the developer terminal 60. The application service 40, the user terminal 10, and the developer terminal 60 are each implemented by a computer 500. As illustrated in FIG. 6, the computer 500 includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls the entire operation of the computer 500. The ROM 502 stores programs, such as an initial program loader (IPL), for driving the CPU 501. The RAM 503 is used as a work area for the CPU 501. The HD 504 stores various types of data such as a program. The HDD controller 505 controls reading or writing of various types of data from or to the HD 504 under control of the CPU 501. The display 506 displays various types of information such as a cursor, a menu, a window, text, or an image. The external device connection I/F 508 is an interface for connecting various external devices to the computer 500. Examples of the external devices include a Universal Serial Bus (USB) memory and a printer.

The network I/F 509 is an interface for performing data communication using the network N2. The bus line 510 is, for example, an address bus or a data bus for electrically connecting the components such as the CPU 501 illustrated in FIG. 6 to one another.

The keyboard 511 is an example of an input device including a plurality of keys to be used for inputting characters, numerical values, various instructions, or the like. The pointing device 512 is an example of an input device to be used for, for example, selecting or executing various instructions, selecting a target for processing, or moving a cursor. The optical drive 514 controls reading or writing of various types of data from or to an optical storage medium 513, which serves as an example of a removable recording medium. Examples of the optical storage medium 513 include a digital versatile disc (DVD) and a compact disc (CD). The medium I/F 516 controls reading or writing (storing) of data from or to a recording medium 515 such as a flash memory.

### Functions

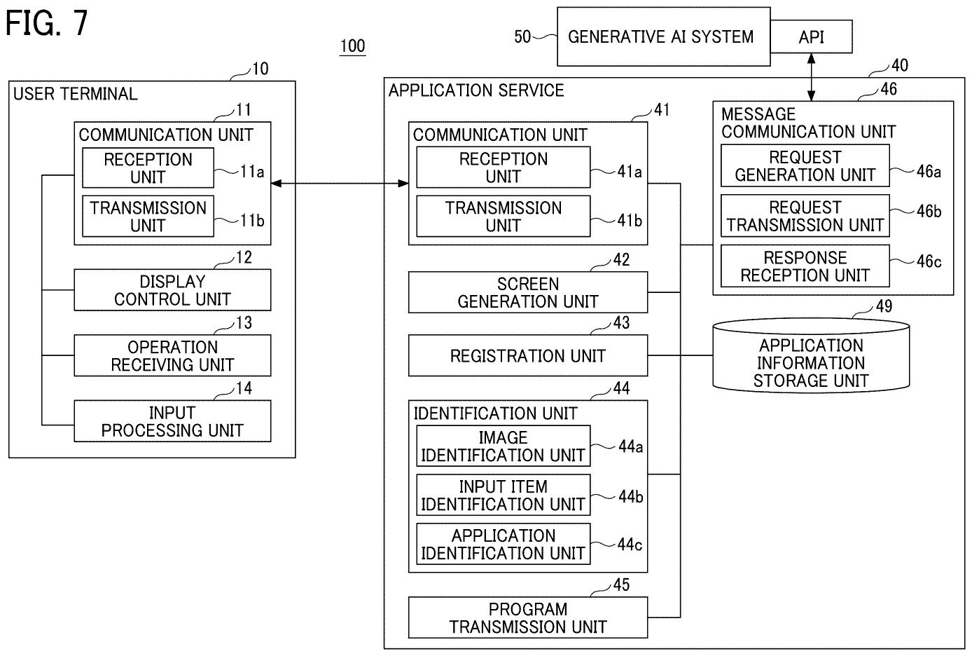

A functional configuration of the information processing system 100 will be described next with reference to FIG. 7. FIG. 7 is a diagram illustrating an example of the functional configuration of the application service 40 and the user terminal 10.

### User Terminal

The user terminal 10 includes a communication unit 11, a display control unit 12, an operation receiving unit 13, and an input processing unit 14. These functional units are functions or units that are implemented by the CPU 501 illustrated in FIG. 6 executing instructions included in one or more programs installed on the user terminal 10. For example, the communication unit 11, the display control unit 12, the operation receiving unit 13, and the input processing unit 14 may be implemented by a web browser and a web application. The web application is transmitted from the application service 40 to the user terminal 10. When the user terminal 10 executes a native application, these functional units may be implemented by the native application.

The communication unit 11 transmits and receives various types of information to and from the application service 40. The communication unit 11 includes a reception unit 11a and a transmission unit 11b. The reception unit 11a receives screen information of an input screen of an application or the like from the application service 40. The transmission unit 11b transmits image data of a business card or the like to the application service 40. The reception unit 11a receives values to be set for input items from the application service 40.

The display control unit 12 interprets screen information of various screens to display the various screens on the display 506.

The operation receiving unit 13 receives various user operations on the various screens displayed on the display 506.

The input processing unit 14 inputs the values transmitted from the application service 40 and corresponding to the input items to the input fields of the input items. The display control unit 12 performs control to display a screen in which the values are set for the respective input items. The input processing unit 14 operates as a result of a program transmitted from the application service 40 being executed by the web browser.

### Application Service

The application service 40 includes a communication unit 41, a screen generation unit 42, a registration unit 43, an identification unit 44, a program transmission unit 45, a message communication unit 46, and an application information storage unit 49. These functional units of the application service 40 are functions or units implemented as a result of the CPU 501 illustrated in FIG. 6 executing instructions included in one or more programs installed on the application service 40. The application information storage unit 49 is implemented by, for example, the HD 504 or the RAM 503 illustrated in FIG. 6. The application information storage unit 49 is not necessarily included in the application service 40. In some embodiments, the application information storage unit 49 is on a network accessible from the application service 40.

The communication unit 41 transmits and receives various types of information to and from the user terminal 10. The communication unit 41 includes a reception unit 41a and a transmission unit 41b. The reception unit 41a receives the image data of a business card or the like from the user terminal 10. The transmission unit 41b transmits the input items and the values for the respective input items to the user terminal 10. The transmission unit 41b transmits a web application to be executed by the user terminal 10 and screen information used by the web application for displaying screens to the user terminal 10.

The screen generation unit 42 generates the screen information of screens to be displayed by the user terminal 10. The screen information is a program written in Hyper Text Markup Language (HTML), JavaScript® Object Notation (JSON), Extensible Markup Language (XML), a script language, a Cascading Style Sheet (CSS), and the like. The screen information may be referred to as a web page. The structure of the web page is specified by HTML, the operation of the web page is defined by the script language, and the style of the web page is specified by the CSS. The user terminal 10 may execute a native application. The native application is an application that cannot be executed unless the application is installed on the user terminal 10. In the case of the native application, the user terminal 10 holds the configuration of the screens, and information to be displayed is transmitted in a form of JSON, XML, or the like.

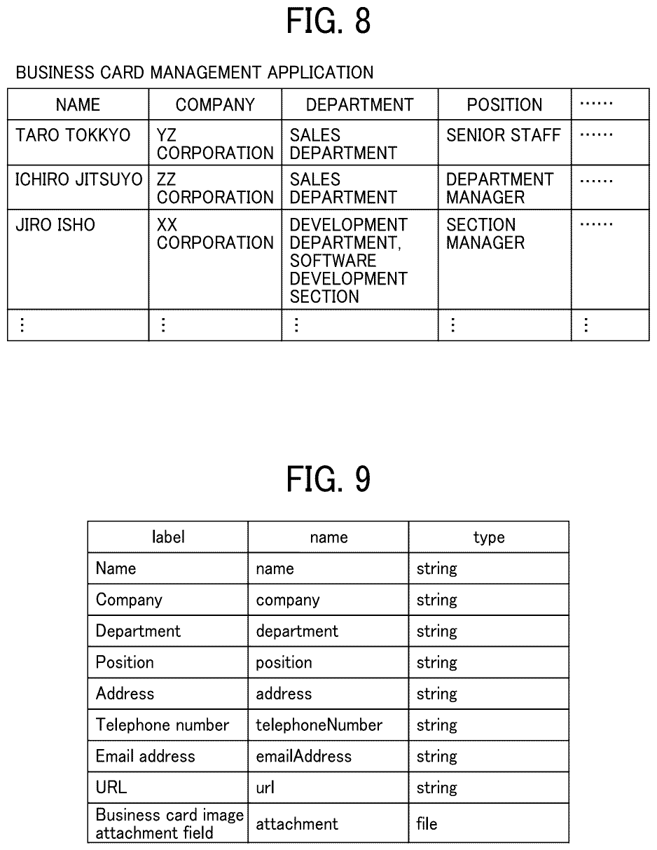

The registration unit 43 manages application information in the application information storage unit 49 on an application-by-application basis. The registration unit 43 registers the values corresponding to the respective input items and transmitted from the user terminal 10 (or may be transmitted from the generative AI system 50) to the application information storage unit 49. The application information includes information set for the input items of the application and information related to the input items of the application. Thus, the application information storage unit 49 stores the information set for the input items of the application and the information related to the input items (see FIGS. 8 and 9).

The identification unit 44 includes an image identification unit 44a, an input item identification unit 44b, and an application identification unit 44c. The image identification unit 44a identifies image data received from the user terminal 10 together with a request for AI-powered input, as extraction-target image data. The input item identification unit 44b receives information for identifying an application from the user terminal 10, and identifies input items of the application based on the information for identifying the application. The application identification unit 44c identifies an application name of the application, based on the information for identifying the application received from the user terminal 10.

In response to a request for a program transmitted from the user terminal 10, the program transmission unit 45 transmits the program to the user terminal 10. This program is a web application, and more specifically JavaScript® included in the web application, for example.

The message communication unit 46 transmits and receives a message to and from the generative AI system 50.

The API of the generative AI system 50 is made publicly available. The message communication unit 46 calls the API to transmit a request message including a chat message to the generative AI system 50. The message communication unit 46 receives a response message from the generative AI system 50. As described above, the request message is information including a chat message. The chat message may be referred to as a request message, which is commonly used in HTTP communication.

The message communication unit 46 includes a request generation unit 46a, a request transmission unit 46b, and a response reception unit 46c. The request generation unit 46a generates a request message for calling the API made publicly available by the generative AI system 50. The request message requests the generative AI system 50 to generate information. The request message includes a text portion, which is called a prompt, and image data, which may be the image data itself or a Uniform Resource Locator (URL) associated with the image data. The request message may further include audio data or the like.

The request transmission unit 46b transmits, to the generative AI system 50, a request including image data and an instruction for extracting values corresponding to the input items from the image data. This request is included in the request message generated by the request generation unit 46a.

The response reception unit 46c receives a response message generated by the generative AI system 50 in response to the instruction transmitted to the generative AI system 50. This response message includes the values corresponding to the input items.

### Application Information Storage Unit

FIG. 8 illustrates an example of information set for input items of an application out of application information. The information set for these input items includes information manually set by the user and information generated by the generative AI system 50. FIG. 8 illustrates the information set for the input items of the application by taking the business card management application as an example. The information set for the input items is managed on a record-by-record basis. In the case of the business card management application, information of one record is referred to as business card information. In the case of the business card management application, input items include “name”, “company”, “department”, and “position”. Values are stored for the respective input items.

FIG. 9 illustrates an example of the information related to the input items of the application out of the application information.

The information related to the input items defines what kind of information is to be stored for each of the input items.

A label item indicates a name (so-called label) of each input item displayed on the input screen 210 of the business card management application.

A name item indicates identification information of each input item used by the application service 40 for management and identification of the input item.

A type item indicates the data format of each input item.

### Operations or Processes

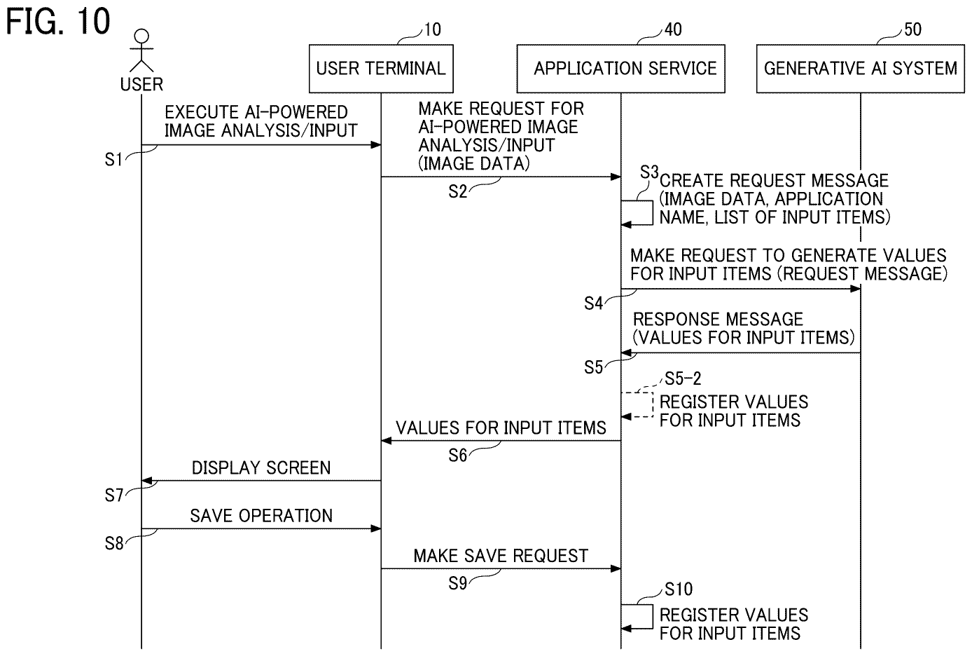

An overall procedure of a process performed by the information processing system 100 will be described with reference to FIG. 10. FIG. 10 is a sequence diagram for describing an example of the process performed by the information processing system 100. The business card management application is already registered to the application service 40. Image data of a business card is set in the application service 40 but no values are set for the other input items.

S1: The user terminal 10 displays the input screen 210 of the business card management application. When the input screen 210 of the business card management application is implemented by the web application, the transmission unit 11b transmits a request for one or more programs to be executed by the user terminal 10 to the application service 40. The program transmission unit 45 of the application service 40 transmits the web application to the user terminal 10. The web application includes a program. The program causes a process to be executed. The process includes displaying a screen for receiving input of a value to an input field from a user. The screen is a screen on which an instruction for extracting information to be input to the input field from image data is receivable. The process includes, when the instruction is received on the screen, transmitting a request to the application service 40. The request includes the image data serving as an extraction target and an instruction for extracting a value corresponding to an input item from the image data. The process includes receiving the value corresponding to the input item from the application service 40. The value is acquired in response to the application service 40 transmitting the request to the generative AI system 50. The process includes inputting and displaying the received value to the input field of the corresponding input item. The process includes transmitting the value input in the input field, to the application service 40 to manage the value in the application service 40. That is, the “instruction for extracting information to be input to an input field from image data” is an instruction for automatically inputting information to the input field.

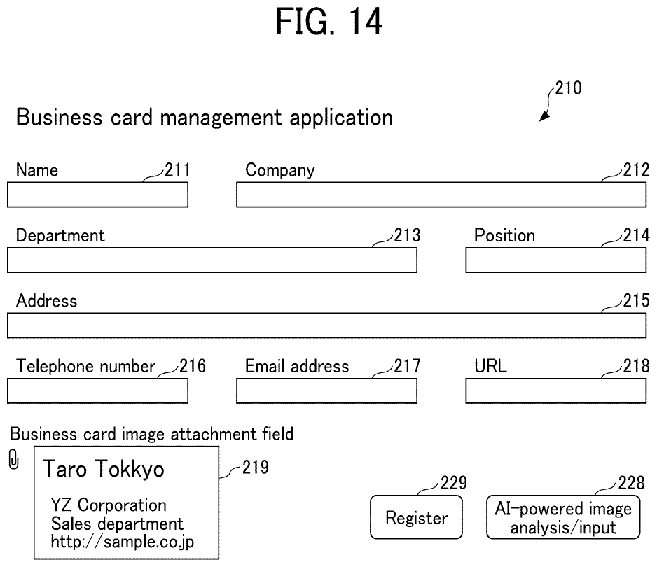

The input screen 210 of the business card management application displays the image data (e.g., a thumbnail) of the business card in the business card image attachment field 219 as illustrated in FIG. 14 (described later). The user presses an “AI-powered image analysis/input” button 228 to start AI-powered image analysis/input. The operation receiving unit 13 of the user terminal 10 receives this operation. The AI-powered image analysis/input refers to a processing sequence of requesting generation of values for the respective input items through analysis of the image data and transmitting the generated values to the user terminal 10.

S2: In response to the operation of pressing the “AI-powered image analysis/input” button 228, the transmission unit 11b of the user terminal 10 designates identification information of the application, a record ID of the currently displayed record (information for identifying the record), and the image data of the business card set in the business card image attachment field 219 in a request for AI-powered image analysis/input, and transmits the request to the application service 40. At this time point, the application displayed by the user terminal 10 is identified. Thus, the identification information of the application is known. When values are set to an application that is not displayed by the user terminal 10, the user selects the application, for example. The record ID of the currently displayed record is identification information of the record currently displayed by the user terminal 10, and thus is known. When the currently displayed record is not registered to the application service 40, the record ID is yet to be assigned. Thus, the user terminal 10 notifies the application service 40 that the record ID is yet to be assigned. The application service 40 assigns a new record ID to the record.

Since the image data of the business card is already set in the application service 40, the communication unit 11 does not necessarily transmit the image data. When the image data of the business card is not set in the application service 40, for example, at a timing immediately after the user terminal 10 captured an image of the business card, the communication unit 11 transmits the image data to the application service 40.

S3: The reception unit 41a of the application service 40 receives the request for AI-powered image analysis/input. The input item identification unit 44b identifies, in the application information storage unit 49, information related to the input items of the application identified by the identification information of the application, and acquires the list of input items.

More specifically, since the label items are appropriate for the input items used by the generative AI system 50, the input item identification unit 44b acquires a list of label items.

The application identification unit 44c acquires the application name of the application identified by the identification information of the application from the application information storage unit 49. The application name is requested because the analysis of the application name by the generative AI system 50 increases the accuracy of generating the values appropriate for the input items. Therefore, the application name may be omitted. The application service 40 may transmit the explanation note of the application to the generative AI system 50 instead of the application name. The explanation note of the application is “This application manages business cards”, for example.

When the user terminal 10 transmits the image data, the image identification unit 44a identifies the image data as extraction-target image data. When the user terminal 10 does not transmit any image data, the image identification unit 44a acquires the original image data displayed in the business card image attachment field 219 of the record identified by the record ID from the application information storage unit 49.

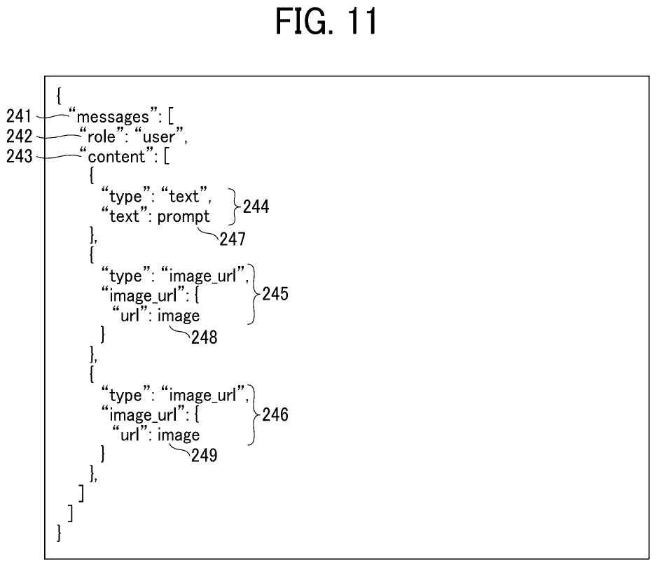

The request generation unit 46a of the application service 40 generates a request message using the application-related information (e.g., the image data of the business card, the application name, and the list of input items). This request message includes an instruction for extracting information corresponding to the input items from the image data. FIG. 11 illustrates a description example of this request message.

S4: The request transmission unit 46b transmits a request to generate values for the input items to the generative AI system 50 together with this request message.

S5: The generative AI system 50 analyzes the image data of the business card to generate the values for the input items, and determines which input item each of the values corresponds to. The generative AI system 50 transmits a response message (i.e., the input items and the respective generated values) to the application service 40.

S5-2: The response reception unit 46c of the application service 40 receives the response message (i.e., the input items and the respective generated values). Upon receipt of the response message, the registration unit 43 of the application service 40 may register the generated values for the respective input items in the application information storage unit 49.

When the registration unit 43 registers the generated values to the application information storage unit 49, the following processing may be skipped. If the user corrects the generated values, the registered values may be overwritten with the corrected values. In the present embodiment, the case of registering the generated values for the respective input items in step S10, which is after the confirmation of the generated values by the user, will be described.

S6: The transmission unit 41b of the application service 40 transmits the input items and the respective generated values to the user terminal 10. The reception unit 11a of the user terminal 10 receives the input items and the respective generated values.

S7: The input processing unit 14 of the user terminal 10 inputs the values corresponding to the input items to the respective input fields of the input items. The display control unit 12 displays the input screen 210 of the business card management application in which the values are set for the input items.

The transmission unit 41b of the application service 40 may transmit screen information for updating the input screen 210 of the business card management application to the user terminal 10, instead of transmitting the input items and the respective generated values.

S8: The user views the input screen 210 of the business card management application to check the values of the respective input items generated by the generative AI system 50. If any of the generated values is incorrect, the user edits the value on the input screen 210. When saving the values of the respective input items on the input screen 210 of the business card management application, the user performs a save operation (e.g., pressing a register button 229 (see FIG. 14)) on the user terminal 10. The operation receiving unit 13 receives the operation.

S9: The transmission unit 11b of the user terminal 10 designates the identification information of the application and the record ID, and transmits a save request to the application service 40 together with the values of the input items and the image data. When the image data has been already transmitted, the retransmission may be omitted.

S10: The reception unit 41a of the application service 40 receives the identification information of the application, the record ID, the save request, and the values of the input items. The registration unit 43 identifies the application based on the identification information of the application, and identifies the record based on the record ID. The registration unit 43 saves (registers) the values in association with the respective input items of the identified record in the application information storage unit 49. The transmission unit 41b of the application service 40 transmits “input OK” (which means that registration of the values is completed) to the user terminal 10. The reception unit 11a of the user terminal 10 receives “input OK”.

### Example of Request Message from Application Service to Generative AI System

FIG. 11 illustrates an example of parameters included in the request message transmitted by the application service 40 to the generative AI system 50 in step S4 in FIG. 10.

“messages” 241 is an API of the generative AI system 50 and indicates that the following is a chat message.

“role” 242 is an API of the generative AI system 50, and indicates a category of the source of the request message. Examples of the category include “user” (indicating the user), “assistant” (indicating AI of the generative AI system 50), and “system” (indicating settings made by the AI assistant).

“content” 243 is an API of the generative AI system 50, and a dialog is set. Since the “content” has an array structure, a prompt and a plurality of pieces of image data may be designated. In FIG. 11, three parameters 244 to 246 are written in the JSON format. Two of the three parameters 244 to 246 are each image data.

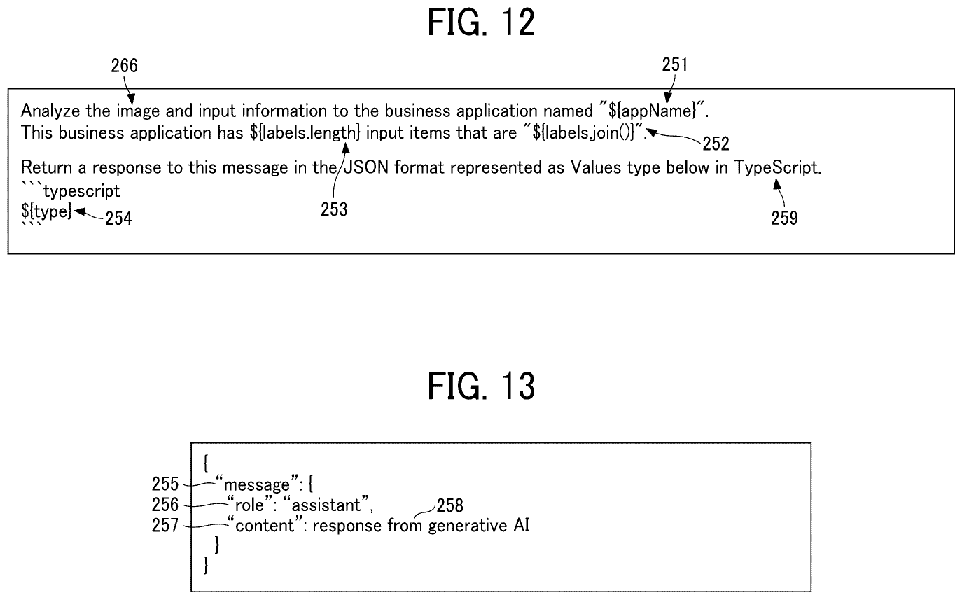

The parameters 244 to 246 represent the format of information transmitted to the generative AI system 50. “type” defines the data type. When the “type” is “text”, the value of the “text” is “prompt” 247. In the “prompt” 247, a prompt is set. FIG. 12 illustrates an example of the prompt set in the “prompt” 247.

When the “type” is “image_url”, the value of the “image_url” is “image” 248 or 249. In the “image” 248 or 249, a URL where image data is saved or an image encoded by Base64 is input. When the application has one input item for image data, the parameters 245 and 246 may be reduced to one.

The request message including the prompt and the images as illustrated in FIG. 11 is transmitted to the generative AI system 50.

FIG. 12 is a diagram for describing the prompt set in the “prompt” 247 in FIG. 11. A character string illustrated in FIG. 12 is a template used by the request generation unit 46a to create the prompt. The character string includes four ${ . . . } expressions. When the request message is transmitted, the application-related information is set in ${appName} 251, $ {labels.join( )} 252, ${labels.length} 253, and ${type} 254. That is, the four ${ . . . } expressions are replaced with the application-related information. The rest of the character string is fixed and is held by the request generation unit 46a in advance. “Analyze the image” 266 at the beginning of the prompt requests analysis of the image data designated by the parameter 245 included in the request message.

The application name is set in the ${appName} 251. In some embodiments, the application name may be omitted. In some embodiments, the explanation note of the application (for describing the application) may be set.

The list of input items is set in the ${labels.join( )} 252.

The number of input items is set in the ${labels.length} 253.

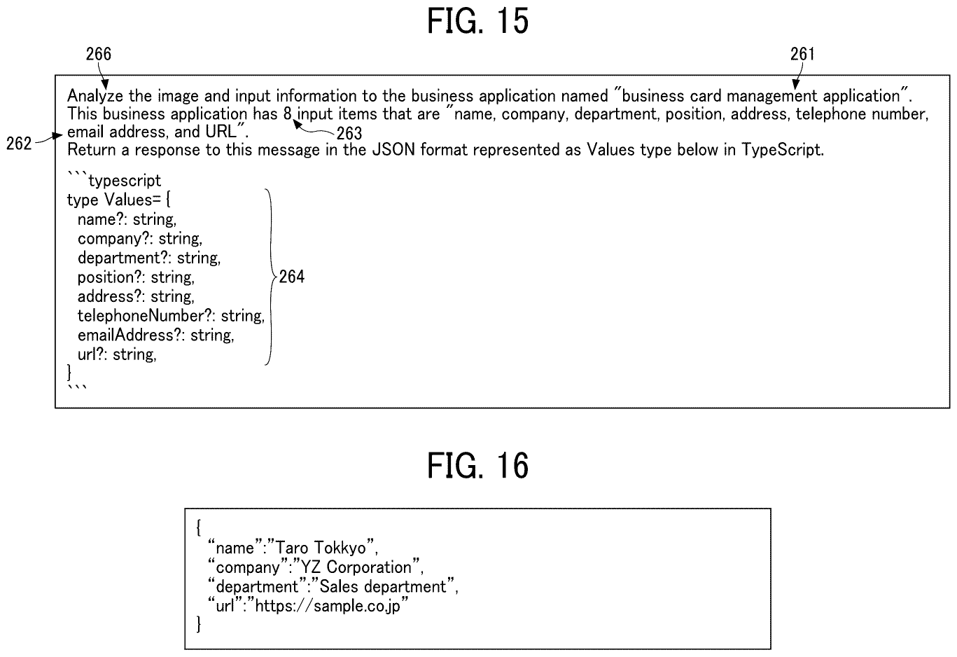

The data format of the input items to be returned in the response message is set in the ${type} 254. “TypeScript” 259 is a statically typed programming language that allows declaration of variable data types within code. In FIG. 12, the JSON format is designated for the ${type} 254. That is, the prompt illustrated in FIG. 12 instructs the generative AI system 50 to return input items and respective values in the JSON format. A specific setting example will be described with reference to FIG. 15.

### Example of Response Message from Generative AI System to Application Service

FIG. 13 illustrates the format of the response message transmitted by the generative AI system 50 to the application service 40 in step S5 in FIG. 10. That is, FIG. 13 presents the format rather than the response message itself.

“messages” 255 indicates that the following is a response message.

“role” 256 indicates a category of a sender that transmits the response message. The sender is “assistant” (i.e., AI of the generative AI system 50) in this example.

“content” 257 presents the content of the response message. In this example, the “content” 257 presents a response 258 (i.e., input items and respective values) from the generative AI system 50. The details of the response 258 from the generative AI system 50 will be described with reference to FIG. 16.

### Example of Setting Values for Input Items Using Image Data

An example of setting values for input items using image data will be described below using the business card management application and the book management application as examples.

### Example of Setting Information Using Image Data of Business Card

With reference to FIG. 14 and other drawings, an example of setting values for input items of the business card management application will be described. FIG. 14 illustrates an example of the input screen 210 of the business card management application displayed by the user terminal 10. In the description of FIG. 14, differences from FIG. 2 will be described. In FIG. 14, the user inputs image data of a business card to the business card image attachment field 219. The user can manually input values to the respective input fields of the input screen 210 of the business card management application.

The business card image attachment field 219 displays a thumbnail of the image data of the business card. In this state, the user presses the “AI-powered image analysis/input” button 228. The “AI-powered image analysis/input” button 228 receives an instruction for extracting values to be input for the input items from the image data. The “AI-powered image analysis/input” button 228 may be enabled (become pressable) when an image of a business card is input to the business card image attachment field 219. This image of the business card is not necessarily registered to the application service 40.

The application-related information of the business card management application will be described. The application name of the business card management application is “business card management application”. According to the information related to the input items in FIG. 9, the list of input items (label items) includes the name, the company, the department, the position, the address, the telephone number, the email address, the URL, and the business card image attachment field. Among these input items, the AI-powered image analysis/input is not performed for the business card image attachment field. Thus, the request generation unit 46a does not include the business card image attachment field in the prompt. The request generation unit 46a uses the input items whose type item is string type in the information related to the input items as the prompt. Thus, the request generation unit 46a can exclude the input item for which the value is not to be input from the prompt. Thus, the list of input items is the name, the company, the department, the position, the address, the telephone number, the email address, and the URL. The number of input items is 8.

The input screen 210 of the business card management application is a screen on which the image data is uploaded. The identification unit 44 identifies the uploaded image data as an image from which the values are to be extracted. Image data of a business card may be uploaded by pressing the business card image attachment field 219 as well as pressing the “AI-powered image analysis/input” button 228. The reception unit 41a of the application service 40 receives information for identifying the application selected by the user. Based on the information for identifying the application, the identification unit 44 identifies the input items (uses the information related to the input items illustrated in FIG. 9). The image identification unit 44a identifies the image data uploaded by the user. The input item identification unit 44b identifies the input items associated with the application and the record ID. The application identification unit 44c identifies the application name of the application.

FIG. 15 illustrates an example of the prompt generated by the request generation unit 46a. The following information is set in the ${appName} 251, the ${labels.join( )} 252, and the ${labels.length} 253 illustrated in FIG. 12.

In the ${appName} 251, “business card management application” 261 is set.

In the ${labels.join( )} 252, “name, company, department, position, address, telephone number, email address, and URL” 262 are set. That is, the label items in the information related to the input items are set. The name items are not set because the name items serve as the identification information, and information irrelevant to the labels (i.e., information with which the generative AI system 50 has difficulty determining the input items) is often set for the name items.

In the ${labels.length} 253, “8” 263 is set.

In the ${type} 254 illustrated in FIG. 12, a data format 264 of each input item is set. The data format 264 is an instruction for extracting information written in the data format as follows:
“name?: string,
company?: string,
department?: string,
position?: string,
address?: string,
telephoneNumber?: string,
emailAddress?: string,
url?: string”.

These are values of the name items and the type items in the information related to the input items illustrated in FIG. 9. The name items of the data format 264 are arranged in the same order as the “name, company, department, position, address, telephone number, email address, and URL” 262.

The name items of the data format 264 are not the label items because the values for the input items returned by the generative AI system 50 are to be used by the application service 40 for settings. The application service 40 identifies the input items not by the values of the label items but by the values of the name items. In some embodiments, however, the values of the label items may be used. In this case, when the values are set to the application service 40, the request generation unit 46a converts the label items into the name items.

“?” at the end of each name item indicates that if there is an input item whose value is not found in the image data, the generative AI system 50 may omit the input item. “string” is the value (i.e., data type) of the type item.

Based on “Analyze the image” 266 at the beginning of the prompt, the generative AI system 50 grasps the instruction for analyzing the image data designated by the parameter 245 included in the request message. The generative AI system 50 then attempts to generate values of the “name, company, department, position, address, telephone number, email address, and URL” 262 from the image data. The generative AI system 50 then determines input items for which values are successfully generated based on the arrangement order in the data format 264, and associates each input item with the corresponding generated value.

FIG. 16 illustrates an example of the response message from the generative AI system 50 in response to the request message including the prompt illustrated in FIG. 15. The generative AI system 50 analyzes the image data of the business card to acquire values corresponding to the “name, company, department, position, address, telephone number, email address, and URL” 262. The generative AI system 50 then associates the values with the respective name items (hereinafter, referred to as input items) included in the data format 264 of the prompt, and returns the values and the respective name items (i.e., input items).
Input item: Value
name: Taro Tokkyo
company: sample1 corporation
department: sales department
url: https://sample.co.jp

The response message does not include “position”, “address”, “telephoneNumber”, and “emailAddress” among the input items included in the data format 264 of the prompt because the “position”, “address”, “telephoneNumber”, and “emailAddress” are not included in the image data of the business card or are not found by the generative AI system 50.

The application service 40 transmits the input items and the values therefor illustrated in FIG. 16 to the user terminal 10. The user terminal 10 requests the application service 40 to set each value associated with the corresponding input item to the business card management application.

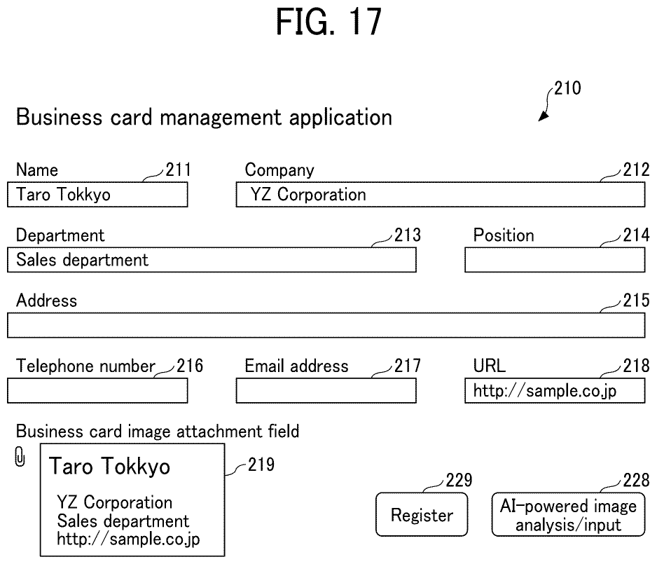

FIG. 17 illustrates an example of the input screen 210 of the business card management application in which the values are set in the business card management application. The input processing unit 14 inputs the values corresponding to the respective input items to the respective input fields of the input items. That is, the values included in the response message are set for the respective input items. The values generated by the generative AI system 50 are set in the name field 211, the company field 212, the department field 213, and the URL field 218.

The user can manually edit the values input for the respective input items by the input processing unit 14. In response to the user pressing the register button 229 on the input screen 210 of the business card management application, the processing in step S8 in FIG. 10 is performed.

As described above, the user designates image data of a business card, so that values obtained through analysis of the image data of the business card can be automatically set for the respective input items. The user terminal 10 can execute any application, and thus can set appropriate values extracted from the image data, for respective input items of the application as well as the business card management application.

### Example of Setting Information Using Image Data of Book Cover

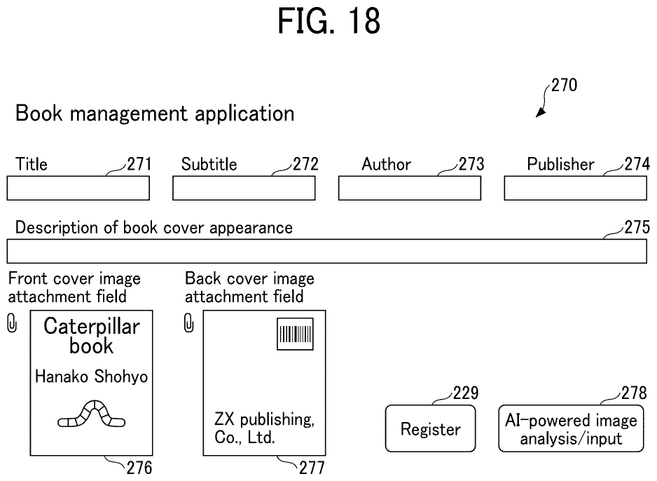

With reference to FIG. 18 and other drawings, an example of setting values for input items of the book management application will be described. FIG. 18 illustrates an example of an input screen 270 of the book management application displayed by the user terminal 10. This book management application has a title field 271, a subtitle field 272, an author field 273, a publisher field 274, a description of book cover appearance 275, a front cover image attachment field 276, and a back cover image attachment field 277. These fields are input items. Users can use the book management application for their work or personally. For example, the user inputs information related to a book which the user has purchased or read for the input items of the book management application. Thus, the user can digitize the information about the book which the user has purchased or read into a list.

To set values for the respective input items using the generative AI system 50, the user inputs image data of the book in the front cover image attachment field 276 and the back cover image attachment field 277. The front cover image attachment field 276 displays a thumbnail of image data of the front cover of the book. The back cover image attachment field 277 displays a thumbnail of image data of the back cover of the book. The image data may be input for one of the front cover image attachment field 276 and the back cover image attachment field 277.

In this state, the user presses an “AI-powered image analysis/input” button 278. The “AI-powered image analysis/input” button 278 may be enabled (become pressable) when image data is input to at least one of the front cover image attachment field 276 or the back cover image attachment field 277. Image data of the front cover or the back cover of the book may be uploaded by pressing the front cover image attachment field 276 or the back cover image attachment field 277 as well as pressing the “AI-powered image analysis/input” button 278. In this case, only the image data set in the pressed field may be transmitted. Alternatively, both of the image data of the front cover and the image data of the back cover may be uploaded in response to pressing of the front cover image attachment field 276 or the back cover image attachment field 277. These images are not necessarily registered to the application service 40.

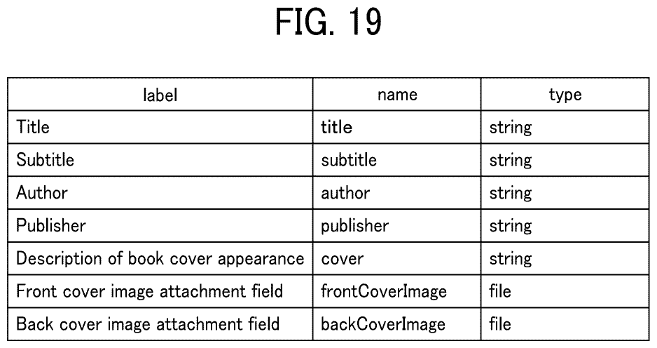

FIG. 19 illustrates an example of information related to the input items of the book management application. Similarly to the information related to the input items of the business card management application (FIG. 9), the information related to the input items of the book management application includes a label item, a name item, and a type item.

The application-related information for the book management application will be described. The application name of the book management application is “book management application”. According to the information related to the input items in FIG. 19, the list of input items (label items) includes “title”, “subtitle”, “author”, “publisher”, “description of book cover appearance”, “front cover image attachment field”, and “back cover image attachment field”. Among these input items, the AI-powered image analysis/input is not performed for the front cover image attachment field and the back cover image attachment field. Thus, the request generation unit 46a does not include the front cover image attachment field and the back cover image attachment field in the prompt. The request generation unit 46a uses the input items whose type item is string type in the information related to the input items as the prompt. Thus, the request generation unit 46a can exclude the input item for which the value is not to be input from the prompt. Therefore, the list of input items is the title, the subtitle, the author, the publisher, and the description of book cover appearance. The number of input items is 5.

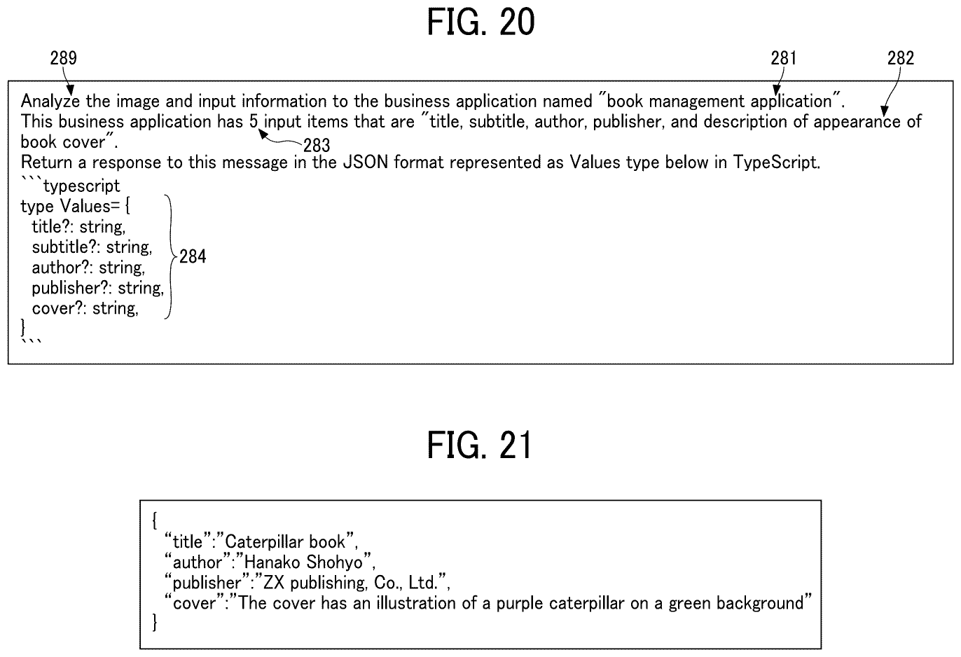

FIG. 20 illustrates an example of the prompt generated by the request generation unit 46a. The following information is set in the ${appName} 251, the ${labels.join( )} 252, and the ${labels.length} 253 illustrated in FIG. 12.

In the ${appName} 251, “book management application” 281 is set.

In the ${labels.join( )} 252, “title, subtitle, author, publisher, and description of book cover appearance” 282 are set.

In the ${labels.length} 253, “5” 283 is set.

In the ${type} 254 illustrated in FIG. 12, a data format 284 of each input item is set.
“title?: string,
subtitle?: string,
author?: string,
publisher?: string,
cover?: string,”

These are values of the name items and the type items in the information related to the input items illustrated in FIG. 19. The name items of the data format 284 are arranged in the same order as the “title, subtitle, author, publisher, and description of book cover appearance” 282.

The name items of the data format 284 are not the label items because the values for the input items returned by the generative AI system 50 are to be used by the application service 40 for settings. The application service 40 identifies the input items not by the values of the label items but by the values of the name items. In some embodiments, however, the values of the label items may be used. In this case, when the values are set to the application service 40, the request generation unit 46a converts the label items into the name items.

“?” at the end of the name item and “string” may be the same as those in FIG. 15.

Based on “Analyze the image” 289 at the beginning of the prompt, the generative AI system 50 grasps the instruction for analyzing the image data designated by the parameter 245 included in the request message. The generative AI system 50 then attempts to generate values of the “title, subtitle, author, publisher, and description of book cover appearance” 282 from the image data. The generative AI system 50 then determines input items for which values are successfully generated based on the arrangement order in the data format 284, and associates each input item with the corresponding generated value.

FIG. 21 illustrates an example of the response message from the generative AI system 50 in response to the request message including the prompt illustrated in FIG. 20. The generative AI system 50 analyzes the image data of the book cover, and acquires values corresponding to the “title, subtitle, author, publisher, and description of book cover appearance” 282.

The generative AI system 50 then associates the values with the respective name items (hereinafter, referred to as input items) included in the data format 284 of the prompt, and returns the values and the respective name items (i.e., input items).
Input item: Value
title: Caterpillar book
author: Hanako Shohyo
publisher: ZX publishing, Co., Ltd.
cover: The cover has an illustration of a purple caterpillar on a green background.

The response message does not include “subtitle” among the input items included in the data format 284 of the prompt because the “subtitle” is not included in the image data of the front cover or the back cover or is not found by the generative AI system 50.

The value corresponding to the “cover”, i.e., “The cover has an illustration of a purple caterpillar on a green background.”, is not included as text in the image data. This value is obtained by the generative AI system 50 by converting how the image data looks like into text data. Thus, the information processing system 100 can automatically set information not included as text in image data to the application service 40.

The application service 40 transmits the input items and the values therefor illustrated in FIG. 21 to the user terminal 10. The user terminal 10 requests the application service 40 to set each input item and the corresponding value to the book management application.

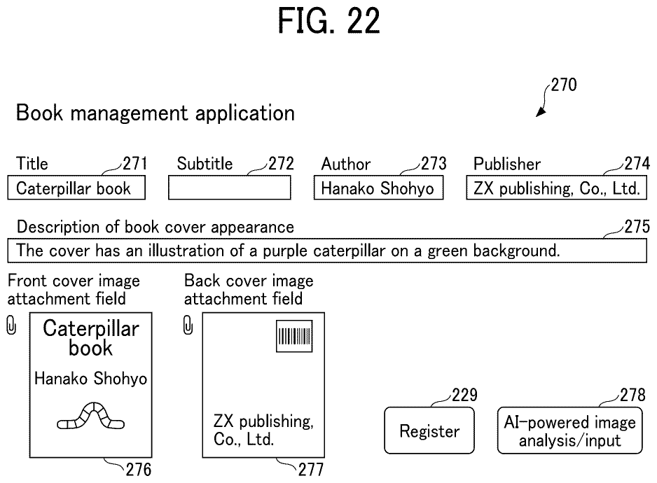

FIG. 22 illustrates an example of the input screen 270 of the book management application in which the values are set in the book management application. The values included in the response message illustrated in FIG. 21 are set for the respective input items. The input processing unit 14 inputs the values corresponding to the respective input items to the respective input fields of the input items. That is, the values are set in the title field 271, the author field 273, the publisher field 274, and the description of book cover appearance 275.

The user can manually edit the values input for the respective input items by the input processing unit 14. In response to the user pressing the register button 229 on the input screen 270 of the book management application, the processing in step S8 in FIG. 10 is performed.

As described above, the user designates a plurality of pieces of image data of a book, so that values obtained through analysis of these pieces of image data can be automatically set for the respective input items. The user terminal 10 can execute any application, and thus can set appropriate values extracted from the image data, for respective input items of the application as well as the book management application.

The information processing system 100 can automatically set, for input items, respective values obtained by the generative AI system 50 through analysis of image data in response to the user designating the image data including values for the input items. That is, the information processing system 100 can extract information from image data without a logic for extracting the information from the image data prepared in advance. The user terminal 10 can set appropriate values extracted from the image data, for the respective input items of any application as well as a single application.

### Second Embodiment

The present embodiment describes the information processing system 100 that sets values for respective input items using a function call capability provided by the generative AI system 50.

In the present embodiment, the description will be given assuming that the hardware configuration diagram in FIG. 6 and the functional block diagram in FIG. 7 described in the first embodiment can also be used.

### Request Message When Function Call Capability is Available

The generative AI system 50 may have the function call capability. The application service 40 specifies a function and types of arguments of the function for the generative AI system 50. The generative AI system 50 generates the arguments of the function in the specified format. This function is called “function call capability”. The application service 40 does not have a function to be called. The existence of such a function causes no issues. In the present embodiment, however, since no such function exists, the term “dummy function” is used. Although the term “function call capability” is used, the generative AI system 50 does not call a function of the application service 40. In the present embodiment, the application service 40 specifies a function and types of arguments of the function for the generative AI system 50 using the function call capability in order to acquire the values for the input items in the formats specified by the application service 40 from the generative AI system 50 with increased certainty.

The use of the function call capability can increase the accuracy of the generative AI system 50 returning values in the JSON format as compared to the case where the application service 40 requests the generative AI system 50 to generate the values for the respective input items in the JSON format and the generative AI system 50 generates the values.

### Process Using Function Call Capability

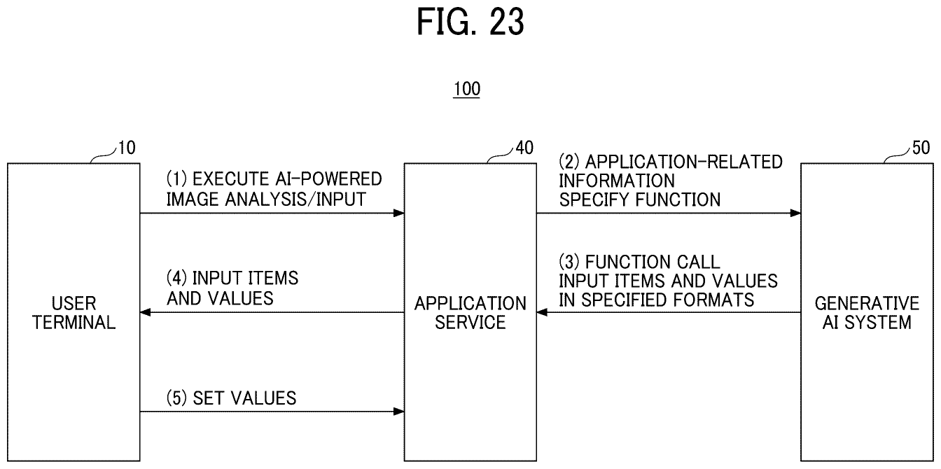

FIG. 23 is a diagram for describing an example of a method of setting values for input items using the function call capability. FIG. 23 assumes that the input screen 210 of the business card management application is displayed.

(1) The user terminal 10 receives an operation to execute the AI-powered image analysis/input from the user. The user terminal 10 transmits a request to execute the AI-powered image analysis/input to the application service 40.

(2) In response to receipt of the request to execute the AI-powered image analysis/input, the application service 40 includes types of arguments of a function in a request message and transmits the request message to the generative AI system 50. The function is a program interface that performs a preset process with a specified argument and returns a return value as a result. In the present embodiment, however, the application service 40 does not have a function. The application service 40 includes formats of arguments of a function (i.e., dummy function) in a request message, and transmits the request message to the generative AI system 50. Consequently, it is expected that the function call from the generative AI system 50 includes the values for the respective input items in the formats specified by the application service 40.

The generative AI system 50 requesting the application service 40 for a call of the dummy function that does not actually exist is called “function call” (tool_call in the present embodiment).

If the application service 40 actually has the function, this does not cause any issues. The application service 40 may execute the function to set the values to the application service 40. Executing a function includes transmitting input items and values to the user terminal 10 and setting the values associated with the respective input items received from the user terminal 10 to the application service 40.

In some embodiments, the application service 40 does not include the formats of the arguments of the function in the same request message as the request message including the application-related information. For example, the application service 40 may include the formats of the arguments of the function in another request message different from the request message including the application-related information and transmits the request messages to the generative AI system 50.

(3) Based on the application-related information and the formats of the arguments of the function included in the transmitted request message(s), the generative AI system 50 transmits a response message including the function call (tool_call) to the application service 40. The expression “the generative AI system 50 requests the application service 40 for a call of a function” does not indicate that the generative AI system 50 requests execution of the function but just proposes values for the input items in the specified format.

That is, the generative AI system 50 includes the input items and the respective values of the application transmitted from the application service 40 in a response message as arguments of the function. These values are generated through the analysis of the application-related information.

(4) The application service 40 receives the response message from the generative AI system 50, acquires the input items and the respective values included in the function call (tool_call) included in the response message, and transmits the input items and the respective values to the user terminal 10.

(5) The user terminal 10 receives the input items and the respective values. The user confirms the values and presses the register button 229 or the like. The user terminal 10 then requests the application service 40 to set the values for the respective input items. The application service 40 saves the received values associated with the respective input items in the application information storage unit 49.

### Example of Request Message to Generative AI System when Generative AI System Has Function Call Capability

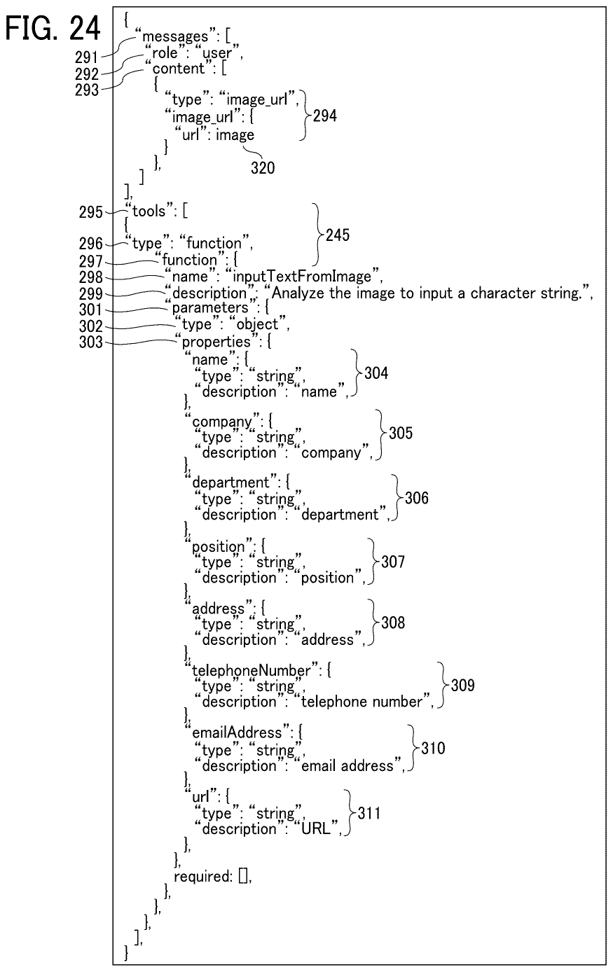

FIG. 24 illustrates an example of a request message including the arguments of the function. The request message illustrated in FIG. 24 assumes the business card management application. “messages” 291, “role” 292, and “content” 293 are substantially the same as the “messages” 241, the “role” 242, and the “content” 243 in FIG. 11, respectively. A parameter 294 describes “type” of the input item being “image_url”. The value of the “image_url” is “image” 320. In the “image” 320, a URL where image data of a business card, for example, is saved or an image encoded by Base64 is input.

The section of the parameter 244 (prompt) in FIG. 11 is replaced with “tools” 295.

The “tools” 295 is an API of the generative AI system 50 and indicates that the following specifies the formats of the arguments of the function.

“type”: “function” 296 indicates that the type of the object is a function.

“function” 297 indicates the description about the function. “name” 298 indicates the name of the function. “description” 299 indicates the capability of the function. The request generation unit 46a holds the “function” 297, the “name” 298, and the “description” 299 in advance. “parameters” 301 provides the description of the arguments of the function. “type”: “object” 302 indicates that the arguments are described in the object format. The “function” 297, the “name” 298, the “description” 299, and the “parameters” 301 are all APIs of the generative AI system 50.

“properties” 303 describes the list of pieces of information related to the input items of the business card management application in a nested structure of the JSON format. That is, the “properties” 303 requests the generative AI system 50 to return the arguments of the function in the JSON format.

“name” 304 specifies how the value for the input item “name” is to be returned. The input item “name” is acquired from the name item of the information related to the input items. Thus, the “name” 304 specifies the “type” of the input item “name” as “string”. “description” specifies returning “name” for the input item “name”. This “name” indicates a request to return the name determined by the generative AI system 50 through analysis of the image data.

The same applies to the following input items “company” 305, “department” 306, “position” 307, “address” 308, “telephoneNumber” 309, “emailAddress” 310, and “url” 311.

As described above, the “tools” 295 includes the list of input items of the application-related information. As in the first embodiment, the image data is included in the parameter 245 illustrated in FIG. 11. The request message illustrated in FIG. 24 does not include the application name. However, in some embodiments, the request message may include the application name. The “name” 298 or the “description” 299 serves as the application name, and may be regarded as the application name.

Based on the “name” 298 or the “description” 299, the generative AI system 50 grasps the instruction for analyzing the image data designated by the parameter 245 included in the request message. The generative AI system 50 then attempts to generate values (i.e., the name, the company, the department, the position, the address, the telephone number, the email address, and the URL) of the “name” 304, the “company” 305, the “department” 306, the “position” 307, the “address” 308, the “telephoneNumber” 309, the “emailAddress” 310, and the “url” 311 from the image data. The generative AI system 50 returns the successfully generated values in the JSON format.

### Example of Response Message from Generative AI System to Application Service

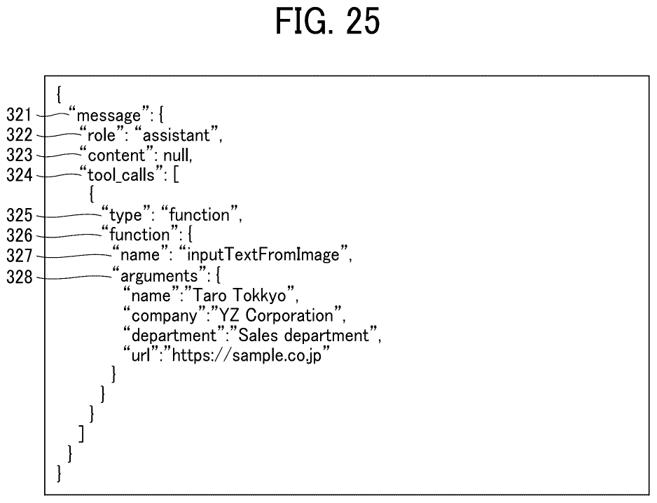

FIG. 25 illustrates an example of a response message from the generative AI system 50 when the generative AI system 50 has the function call capability. “messages” 321, “role” 322, and “content” 323 are substantially the same as the “messages” 255, the “role” 256, and the “content” 257 in FIG. 13, respectively. With the response message illustrated in FIG. 25, the generative AI system 50 requests a function call to the application service 40.

“tool_calls” 324 indicates that the following description is a function call. That is, the generative AI system 50 requests to call the dummy function that does not actually exist to the application service 40. In some embodiments, the function may actually exist.

“type”: “function” 325 indicates that the type of the object is a function.

“function” 326 indicates the description about the function.

“name” 327 indicates the name of the function.

“arguments” 328 indicates the arguments of the function. The arguments include the input items and the respective values below. That is, the generative AI system 50 analyzes image data of a business card, and generates values in association with the respective name items (i.e., input items) in the JSON format specified by the “properties” 303 in FIG. 24.
Input item: Value
name: Taro Tokkyo
company: sample1 corporation
department: sales department
url: https://sample1.co.jp

These input items and values match the information included in the response message illustrated in FIG. 16 in the first embodiment. The application service 40 transmits the input items and the respective values illustrated in FIG. 25 to the user terminal 10. The user terminal 10 requests the application service 40 to set the input items and the respective values to the business card management application. Consequently, the values for the respective input items are set in the input screen 210 of the business card management application as illustrated in FIG. 17.

The present embodiment provides the effects of the first embodiment, and also increases the accuracy of the generative AI system 50 returning the values in the JSON format. Since the application service 40 can acquire the values for the respective input items in the JSON format, the application service 40 can acquire the values for the respective input items for sure.

### Third Embodiment

In the present embodiment, variations common to the first and second embodiments will be described.

### Selection of Image Data for Use in AI-Powered Image Analysis/Input

One record of an application may have a plurality of pieces of image data. For example, the business card management application may have the business card image attachment field and a face image attachment field. The image data set in the face image attachment field represents a face image of a client, and thus does not include a value of the input item. In this case, the analysis of the face image of the client by the generative AI system 50 increases cost in terms of time and processing load.

In the case of the generative AI system 50 of a pay-per-use type, the analysis of the face image of the client incurs extra cost.

Accordingly, it is effective to allow the user to select image data for use in AI-powered image analysis/input on the input screen 210 of the business card management application.

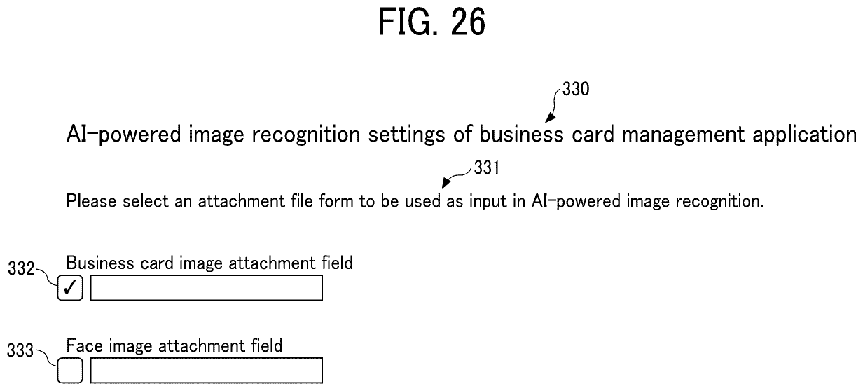

FIG. 26 illustrates an example of an image data selection screen 330 displayed as a portion or a pop-up screen of the input screen 210 of the business card management application displayed by the user terminal 10. The image data selection screen 330 is displayed in response to pressing of the “AI-powered image analysis/input” button 228 in the case of being displayed as a pop-up screen. The image data selection screen 330 has a message 331, i.e., “Please select an attachment file form to be used as input in AI-powered image recognition.”. When the business card management application has the business card image attachment field and the face image attachment field, the image data selection screen 330 has a checkbox 332 for selecting the business card image attachment field and a checkbox 333 for selecting the face image attachment field. The user desires to have the generative AI system 50 analyze only the image data set in the business card image attachment field. Thus, the user selects the checkbox 332 (for the business card image attachment field).

Consequently, the request message generated by the request generation unit 46a in step S3 in FIG. 10 includes only the image data set in the business card image attachment field of which the checkbox 332 is checked. Thus, the content of the prompt is the same as that in FIG. 15.

### Request Message with Specified Input Range of Value

Some input items of an application may have an input range. For example, an input item with the data format of the character string may have the maximum number and minimum number of characters that can be input. An input item whose value is the numerical value may have the maximum and minimum values that can be input.

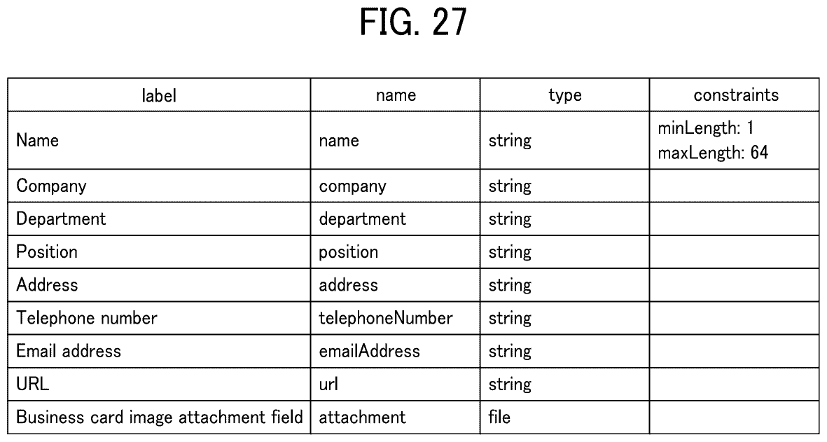

FIG. 27 illustrates an example of information related to an input item having an input range. As compared with FIG. 9, FIG. 27 further illustrates a constraints item. The constraints item defines an input range of the value of an input item. For example, the input range whose minimum number of characters (minLength) is 1 and maximum number of characters (maxLength) is 64 is set for the input item with the label item of “name”.

When generating a prompt, the request generation unit 46a includes information on the input range in the prompt. This can prevent the value generated by the generative AI system 50 from being outside the input range set in the application.

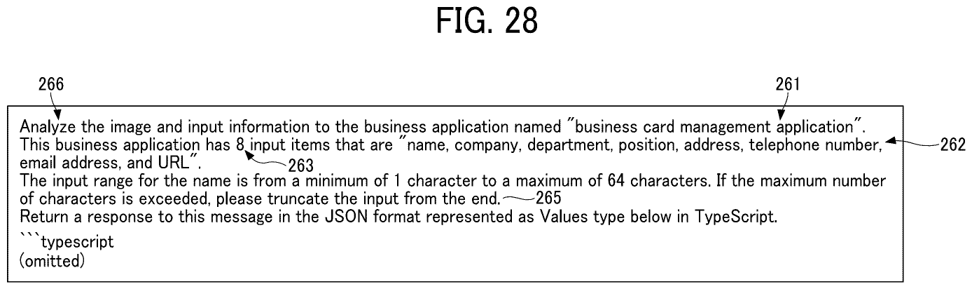

FIG. 28 illustrates an example of a prompt for requesting values for the input items in the JSON format without using the function call. In FIG. 28, differences from FIG. 15 will be described. The prompt illustrated in FIG. 28 additionally includes text data 265, i.e., “The input range for the name is from a minimum of 1 character to a maximum of 64 characters. If the maximum number of characters is exceeded, please truncate the input from the end.” “1” and “64” in the text data 265 are changed in accordance with the constraints item of the information related to the input items illustrated in FIG. 27.

That is, as indicated below, ${ . . . } for the maximum number of characters and the minimum number of characters are additionally set in the template illustrated in FIG. 12.

“The input range for the name is from a minimum of ${minLength} character to a maximum of ${maxLength} characters. If the maximum number of characters is exceeded, please truncate the input from the end.” The request generation unit 46a replaces the $ {minLength} with “1” and the “${maxLength}” with “64”. Thus, the text data 265 other than “1” and “64” is fixed.

The generative AI system 50 analyzes the text data 265 included in the prompt, and generates the value for the “name” so that the value is not outside the input range.

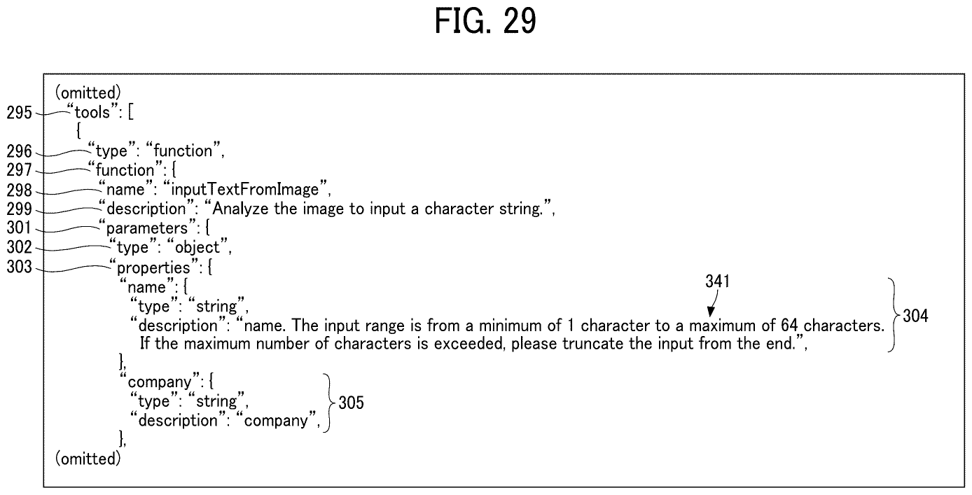

FIG. 29 illustrates an example of a request message when the generative AI system 50 has the function call capability. In the description of FIG. 29, differences from FIG. 24 will be described. In FIG. 29, text data 341 is added to the “name” 304.

The text data 341 reads “The input range for the name is from a minimum of 1 character to a maximum of 64 characters. If the maximum number of characters is exceeded, please truncate the input from the end.” The text data 341 specifies the presence of the input range for the “name” and processing to be performed when the value is outside the input range.

The generative AI system 50 analyzes the description (i.e., the presence of the input range and the processing to be performed when the value is outside the input range) related to the arguments of the function, and generates the value so that the value to be generated for the input item “name” is not outside the input range.

In addition to the input range, the data format of the date (e.g., “Month Day, Year” or MM/DD/YYYY), the data format of the time (e.g., hhmmss), the data format of the telephone number (e.g., presence or absence of hyphens), the data format of the facsimile number (e.g., presence or absence of hyphens), the data format of the postal code (e.g., presence or absence of hyphens), the data format of the address (e.g., presence or absence of hyphens in details below the block number), the data format of the email address (e.g., containing a single @ symbol), or the like may be defined.

The present embodiment provides the effects of the first and second embodiments, and prevents the value generated by the generative AI system 50 from being outside the input range set in the application.

### Few-Shot Prompting

There is a technique called few-shot prompting for increasing the accuracy in the generation of a value by providing the generative AI system 50 with some output examples in the prompt. In the present embodiment, performing few-shot prompting can increase the accuracy in the generation of the value to be generated for the input item.

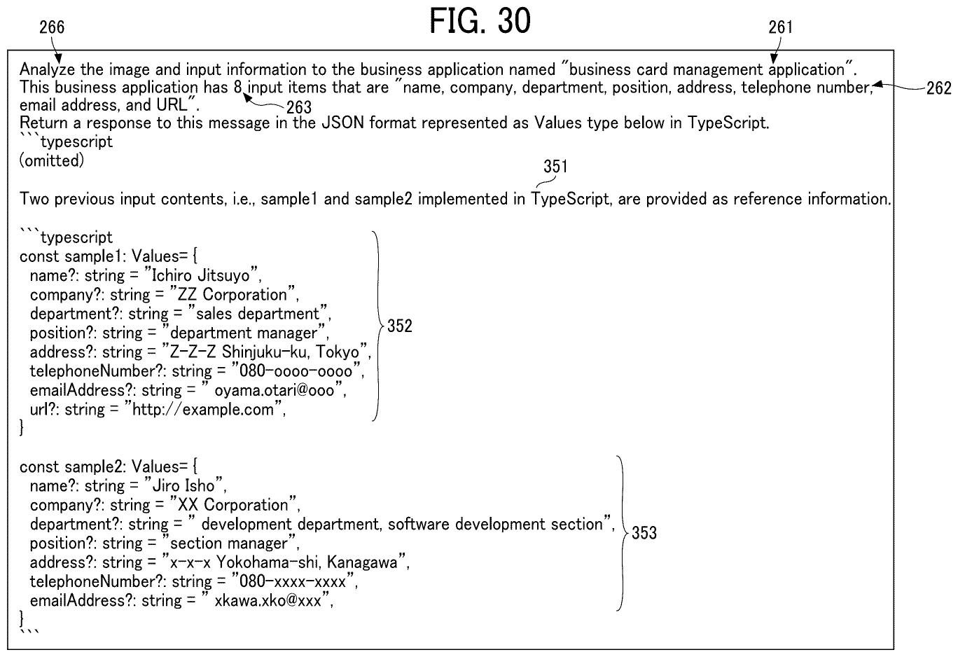

FIG. 30 illustrates an example of a prompt using few-shot prompting. Few-shot prompting is a technique involving the inclusion of one or more output examples in the prompt. Thus, the request generation unit 46a includes the information (FIG. 8) that has been registered to the application service 40 in the prompt. In FIG. 30, differences from FIG. 15 will be described.

A message 351 is that “Two previous input contents, i.e., sample1 and sample2 implemented in TypeScript, are provided as reference information.” and indicates that the following is the information that has been registered in the application and notifies the generative AI system 50 to use the information as reference.

“const sample1” 352 indicates the first input content. In the “const sample1” 352, values of one record of the information already registered in the application are written in association with the respective name items, which are information related to the input items.

“const sample2” 353 indicates the second input content. In the “const sample2” 353, values of one record of the information already registered in the application are written in association with the respective name items, which are information related to the input items.

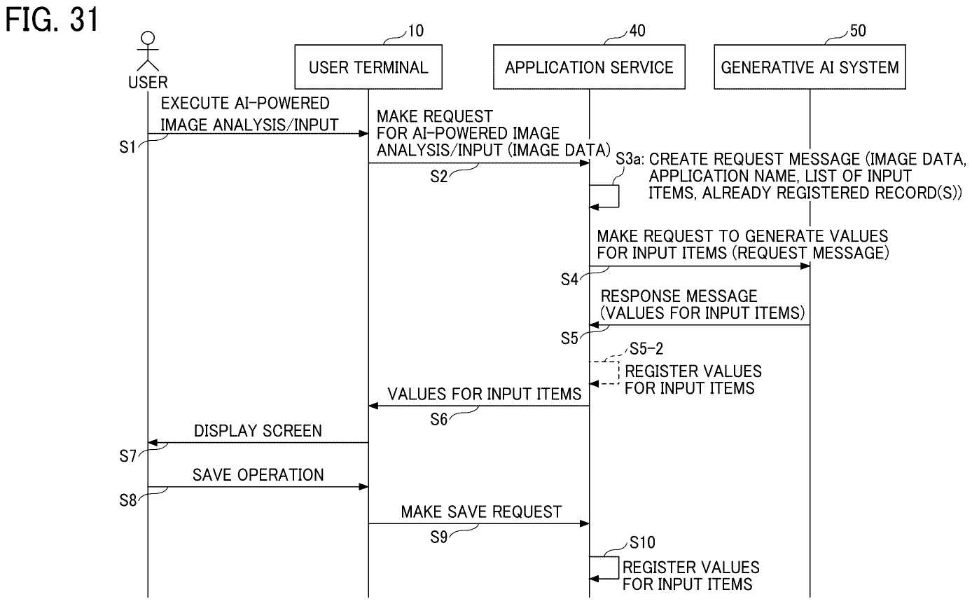

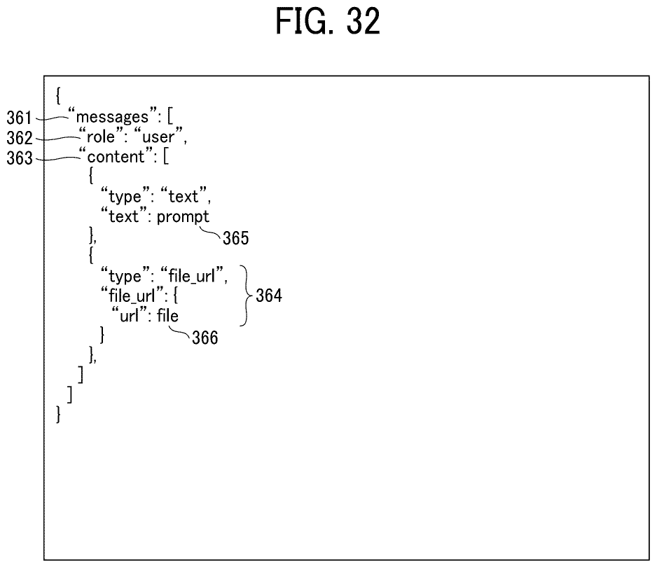

FIG. 31 is a sequence diagram for describing an example of a process performed by the information processing system 100 when few-shot prompting is used. In FIG. 31, differences from FIG. 10 will be described. In FIG. 31, processing in steps S3a and S5 is different from the processing in steps S3 and S5 in FIG. 10.

S3a: The reception unit 41a of the application service 40 receives a request for AI-powered image analysis/input. The method of identifying the list of input items, the application name, and the image data (when not transmitted from the user terminal 10) may be the same as that used in FIG. 10. The application identification unit 44c identifies one or more already registered records of the application (e.g., the business card management application) executed by the user terminal 10, from the application information identified by the identification information of the application.

The request generation unit 46a of the application service 40 generates a request message using the application-related information (e.g., the image data of the business card, the application name, and the list of input items) and the one or more already registered records. This request message includes an instruction for extracting information corresponding to the input items from the image data.

S4: The request transmission unit 46b transmits a request to generate values for the input items to the generative AI system 50 together with this request message.

S5: The generative AI system 50 analyzes the image data to generate the values from the image data, and determines which input item each of the generated values corresponds to with reference to the one or more records. The generative AI system 50 transmits a response message (i.e., the input items and the respective generated values) to the application service 40.

The following processing may be substantially the same as that in FIG. 10.

Performing few-shot prompting makes it easier for the generative AI system 50 to determine the value to be associated with each input item and can increase the accuracy in the generation of the values. This makes it easier for the generative AI system 50 to generate the value corresponding to each input item.

The present embodiment provides the effects of the first and second embodiments, and increases the accuracy in the generation of values to be generated for the respective input items by performing few-shot prompting.

### Analysis of File Other Than Image Data

The generative AI system 50 can analyze a file in a format of document data, video data, or audio data other than text data and image data. In the present embodiment, to generate values for the respective input items, the user terminal 10 can transmit the document data, the video data, and the audio data just like the image data to the generative AI system 50 via the application service 40.

FIG. 32 illustrates an example of a request message transmitted by the application service 40 to the generative AI system 50. In the description of FIG. 32, differences from FIG. 11 will be described. “messages” 361, “role” 362, and “content” 363 are substantially the same as the “messages” 241, the “role” 242, and the “content” 243 in FIG. 11, respectively. Each parameter has a set of “type” and a value thereof. In a parameter 364, “file_url” is newly specified as the “type”. When the “type” is “file_url”, the value of the “url” is “file” 366. In the “file” 366, a URL where the file is saved or an image encoded by Base64 is input.

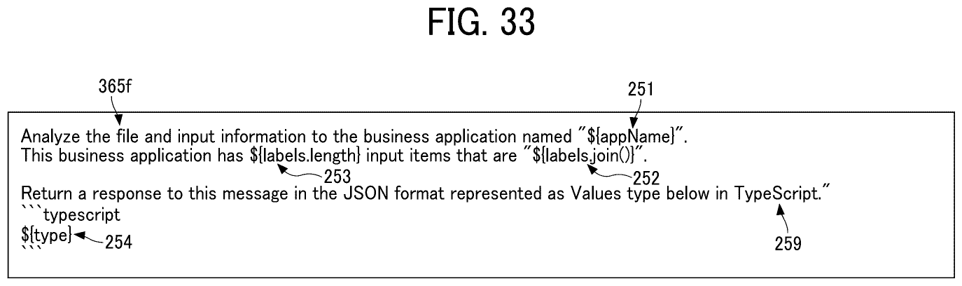

FIG. 33 illustrates an example of a character string set in a “prompt” 365 in FIG. 32. In FIG. 33, differences from FIG. 12 will be described. In FIG. 33, the text in the beginning part in FIG. 12 is changed from “image” to “file” 365f. The analysis of the prompt allows the generative AI system 50 to understand the instruction for performing recognition on the “file 365f”. The generative AI system 50 analyzes the “file” included in the request message to determine to generate values for the respective input items of the business card management application.

As described above, the request generation unit 46a changes the description of the prompt, so that the format of the data to be analyzed by the generative AI system 50 can be changed. For example, in the case of video data, even if a business card is captured as a video, the generative AI system 50 can generate values for the input items. In the case of document data, even if a memo or a form includes the name or the like, the generative AI system 50 can generate values for the input items. In the case of audio data, even if a conversation includes the name or the like, the generative AI system 50 can generate values for the input items.

The prompt allows a plurality of files to be designated. Thus, the request generation unit 46a may include two or more of image data, document data, video data, and audio data in a single prompt, and transmits the prompt to the generative AI system 50. In this case, the “file” 365f is changed to “Analyze the image, document, video, and audio”.

The present embodiment provides the effects of the first and second embodiments, and allows the generative AI system 50 to analyze a file of text data or image data and generate values for the respective input items.

### Variations

While the present disclosure has been described above using the embodiments, the embodiments do not limit the present disclosure in any way. Various variations and replacements may be made within a scope not departing from the gist of the present disclosure.

For example, in the present embodiment, the application service 40 transmits the image data to the generative AI system 50. In some embodiments, the image data may be saved in a predetermined server. In this case, the application service 40 transmits information for designating the image data in the server to the generative AI system 50. The generative AI system 50 acquires the image data from the server and generates the values for the respective input items from the image data.

In the present embodiment, the JSON format is used to represent the values generated for the input items by the generative AI system 50. In some embodiments, the values of the input items may be represented in another format such as XML or CSV.

In the present embodiment, the user terminal 10 sets the generated values for the respective input items of the application managed by the application service 40. In some embodiments, the user terminal 10 may set the generated values for the respective input items of a native application that operates thereon. For example, when the user terminal 10 executes a spreadsheet application, the user terminal 10 may set the generated values to respective cells of the spreadsheet application.

The apparatuses or devices described in one or more embodiments are just one example of plural computing environments that implement the one or more embodiments disclosed herein. In some embodiments, the application service 40 includes multiple computing devices, such as a server cluster. The multiple computing devices communicate with one another through any type of communication link including a network, a shared memory, or the like and perform the processes disclosed herein.

Further, the application service 40 can be configured to share the processing steps disclosed in the embodiments described above, for example, the processing steps illustrated in FIG. 10 and other drawings, in various combinations. For example, a process executed by a predetermined unit may be executed by multiple information processing apparatuses included in the application service 40. The application service 40 may be integrated into one server apparatus or may be divided into a plurality of devices.

In the example configurations illustrated in, for example, FIG. 7, the configurations are divided according to main functions to facilitate understanding of processing performed by the application service 40. No limitation on the present disclosure is intended by how the functions are divided by process or by the name of the functions. The processes of the application service 40 may be divided into more units of processing in accordance with the content of the processes. In addition, the division may be performed so that one processing unit includes more processes.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure provides significant improvements in computer capabilities and functionalities. These improvements allow a user to utilize a computer which provides for more efficient and robust interaction with a table which is a way to store and present information in an information processing apparatus. Moreover, the present disclosure provides for a better user experience through the use of a more efficient, powerful and robust user interface. Such a user interface provides for a better interaction between a human and a machine.

### Aspects

According to Aspect 1, an information processing apparatus to be communicably connected to a terminal apparatus and a generative artificial intelligence (AI) system via a network includes a registration unit, a request transmission unit, a request reception unit, and a transmission unit. The registration unit registers information input on a screen displayed on the terminal apparatus for receiving input of information to an input field of an input item from a user. The screen is a screen on which an instruction for extracting information to be input to the input field from image data is receivable. When the instruction is received on the screen, the request transmission unit transmits a request to the generative AI system. The request includes the image data serving as an information extraction target and the instruction for extracting the information corresponding to the input item from the image data. The response reception unit receives the information corresponding to the input item from the generative AI system as a response to the request. The transmission unit transmits, to the terminal apparatus, the information corresponding to the input item and transmitted from the generative AI system, to cause the terminal apparatus to display another screen in which the information corresponding to the input item is input in the input field of the corresponding input item in the screen.

According to Aspect 2, in the information processing apparatus of Aspect 1, the request transmission unit further transmits information for calling a function to the generative AI system. The function causes the registration unit to operate. The response reception unit receives information for designating the function and the information corresponding to the input item from the generative AI system. The registration unit registers the information input on the screen through execution of the function.

According to Aspect 3, in the information processing apparatus of Aspect 1, the request transmission unit further transmits information for calling a dummy function that does not exist to the generative AI system. The response reception unit receives information for designating the dummy function and the information corresponding to the input item from the generative AI system. The registration unit registers the information input on the screen.

According to Aspect 4, in the information processing apparatus of any one of Aspects 1 to 3, the transmission unit transmits, to the terminal apparatus, the information corresponding to the input item and to be input to the input field of the input item, or transmits, to the terminal apparatus, information of said another screen in which the information corresponding to the input item is input in the input field of the corresponding input item in the screen.

According to Aspect 5, in the information processing apparatus of any one of Aspects 1 to 4, the screen includes a screen for receiving uploading of the image data. The information processing apparatus further includes an identification unit. The identification unit identifies the uploaded image data as the image data serving as the information extraction target.

According to Aspect 6, in the information processing apparatus of Aspect 5, the information processing apparatus includes a server apparatus to provide an application for managing the information input by the user to the input field of the input item. The information processing apparatus includes a reception unit. The reception unit receives information for identifying an application selected by the user. The identification unit identifies the input item based on the information for identifying the application.

According to Aspect 7, the information processing apparatus of Aspect 3 further includes a request generation unit. The request generation unit generates the request.

According to Aspect 8, in the information processing apparatus of any one of Aspects 1 to 7, the request transmission unit transmits a data format of the input item and the instruction for extracting information written in the data format of the input item to the generative AI system.

According to Aspect 9, in the information processing apparatus of Aspect 8, the information processing apparatus includes a server apparatus to provide an application for managing the information input by the user to the input field of the input item. The request transmission unit transmits the request to the generative AI system. The request includes a list of input items including the input item and a name of the application.

According to Aspect 10, in the information processing apparatus of any one of Aspects 1 to 9, the information processing apparatus includes a server apparatus to provide an application for managing the information input by the user to the input field of the input item. The application includes an application created by receiving setting of the input item from a user.

According to Aspect 11, in the information processing apparatus of Aspect 5, the information processing apparatus includes a server apparatus to provide an application for managing the information input by the user to the input field of the input item. The identification unit includes an image identification unit, an input item identification unit, and an application identification unit. The image identification unit identifies the image data uploaded by the user. The input item identification unit identifies the input item associated with the application. The application identification unit identifies a name of the application.

According to Aspect 12, in the information processing apparatus of Aspect 7, the transmission unit transmits one or more programs to be executed by the terminal apparatus to the terminal apparatus. The terminal apparatus executes a web browser. An input processing unit that inputs the information corresponding to the input item and received by the terminal apparatus to the input field of the input item operates by execution of the one or more programs transmitted from the information processing apparatus on the web browser.

1. An information processing apparatus communicably connected to a terminal apparatus and a generative artificial intelligence (AI) system via a network, the information processing apparatus comprising:
circuitry configured to:
register information input on a screen displayed on the terminal apparatus, the screen being configured to receive an instruction for extracting information to be input to an input field of an input item from image data;
in response to reception of the instruction on the screen, transmit a request to the generative AI system, the request including the image data from which the information is extracted and the instruction for extracting the information corresponding to the input item from the image data;
receive the information corresponding to the input item from the generative AI system in response to the request; and
transmit, to the terminal apparatus, the information corresponding to the input item and received from the generative AI system, to cause the terminal apparatus to display the screen in which the information corresponding to the input item is input to the input field of the corresponding input item.

2. The information processing apparatus according to claim 1, wherein the circuitry is further configured to:
transmit information for calling a function to the generative AI system, the function causing registration of the information to be executed; and
receive information for designating the function from the generative AI system in addition to the information corresponding to the input item,
wherein the circuitry is configured to register the information input on the screen through execution of the function.

3. The information processing apparatus according to claim 1, wherein the circuitry is further configured to:
transmit information for calling a dummy function that does not exist to the generative AI system; and
receive information for designating the dummy function from the generative AI system in addition to the information corresponding to the input item,
wherein the circuitry is configured to register the information input on the screen.

4. The information processing apparatus according to claim 1, wherein the circuitry is configured to transmit, to the terminal apparatus, the information corresponding to the input item and to be input to the input field of the input item.

5. The information processing apparatus according to claim 1, wherein the circuitry is configured to transmit, to the terminal apparatus, data of the screen in which the information corresponding to the input item is input to the input field of the corresponding input item.

6. The information processing apparatus according to claim 1, wherein
the screen is configured to receive uploading of the image data, and
the circuitry is configured to identify the uploaded image data as the image data from which the information is extracted.

7. The information processing apparatus according to claim 6, wherein
the information processing apparatus includes a server that provides an application for managing the information input to the input field of the input item, and
the circuitry is configured to:
receive information for identifying an application selected by a user; and
identify the input item based on the information for identifying the application.

8. The information processing apparatus according to claim 3, wherein the circuitry is configured to generate the request.

9. The information processing apparatus according to claim 1, wherein the circuitry is configured to transmit a data format of the input item and the instruction for extracting information written in the data format of the input item to the generative AI system.

10. The information processing apparatus according to claim 9, wherein
the information processing apparatus includes a server to provide an application for managing the information input to the input field of the input item, and
the circuitry is configured to transmit the request to the generative AI system, the request including a list of input items including the input item and a name of the application.

11. The information processing apparatus according to claim 1, wherein
the information processing apparatus includes a server that provides an application for managing the information input to the input field of the input item, and
the application includes an application created by receiving setting of the input item from a user.

12. The information processing apparatus according to claim 6, wherein
the information processing apparatus includes a server that provides an application for managing the information input to the input field of the input item, and
the circuitry is configured to:
identify the image data uploaded by a user;
identify the input item associated with the application; and
identify a name of the application.

13. An information processing system comprising:
an information processing apparatus; and
a terminal apparatus communicably connected to the information processing apparatus via a network,
the terminal apparatus comprising first circuitry configured to:
display a screen for receiving input of a value to an input field of an input item, the screen being configured to receive an instruction for extracting a value to be input to the input field from image data; and
in response to reception of the instruction on the screen, transmit a request to the information processing apparatus, the request including the image data from which the value is extracted and the instruction for extracting the value corresponding to the input item from the image data;
the information processing apparatus comprising second circuitry configured to:
transmit the request received from the terminal apparatus to a generative artificial intelligence (AI) system;
receive the value corresponding to the input item from the generative AI system in response to the request; and
transmit, to the terminal apparatus, the value corresponding to the input item and received from the generative AI system, wherein
the first circuitry is configured to:
display the screen in which the value corresponding to the input item and received from the information processing apparatus is input to the input field of the corresponding input item; and
transmit the value input to the input field to the information processing apparatus, and
the second circuitry is configured to register the value input to the input field and received from the terminal apparatus.

14. The information processing system according to claim 13, wherein
the second circuitry is configured to transmit one or more programs to be executed by the terminal apparatus to the terminal apparatus, and
the first circuitry is configured to execute the one or more programs on a web browser to input the received value corresponding to the input item to the input field of the input item.

15. An information processing method performed by an information processing apparatus communicably connected to a terminal apparatus and a generative artificial intelligence (AI) system via a network, the information processing method comprising:
registering information input on a screen displayed on the terminal apparatus, the screen being configured to receive an instruction for extracting information to be input to an input field of an input item from image data;
in response to reception of the instruction on the screen, transmitting a request to the generative AI system, the request including the image data from which the information is extracted and the instruction for extracting the information corresponding to the input item from the image data;
receiving the information corresponding to the input item from the generative AI system in response to the request; and
transmitting, to the terminal apparatus, the information corresponding to the input item and received from the generative AI system, to cause the terminal apparatus to display the screen in which the information corresponding to the input item is input to the input field of the corresponding input item.
